(19) United States
(12) Patent Application Publication
(10) Pub. No.: US 2023/0196722 A1
(43) Pub. Date: Jun. 22, 2023

(54) LEARNING APPARATUS AND CONTROL METHOD THEREOF

(71) Applicant: CANON KABUSHIKI KAISHA, Tokyo (JP)

(72) Inventors: Hiroshi YOSHIKAWA, Kanagawa (JP); Takamasa TSUNODA, Tokyo (JP)

(21) Appl. No.: 18/066,356

(22) Filed: Dec. 15, 2022

(30) Foreign Application Priority Data
Dec. 20, 2021 (JP) 2021-206255
Sep. 16, 2022 (JP) 2022-148404

(51) Int. Cl. G06V 10/75; G06T 7/11; G06V 10/25

(52) U.S. Cl. CPC G06V 10/758; G06T 7/11; G06V 10/25; G06V 2201/07; G06T 2207/20081

(57) ABSTRACT

A learning apparatus trains an estimator that executes a recognition task. The learning apparatus comprises: an obtaining unit configured to obtain a plurality of training data items including input data and supervisory data corresponding to the input data; a calculating unit configured to calculate statistic information relating to a predetermined perspective in the plurality of training data items; a determining unit configured to determine a degree of importance of each training data item included in the plurality of training data items based on the statistic information; and a control unit configured to control training of the estimator based on the degree of importance. The determining unit determines the degree of importance of each training data item such that unevenness of the plurality of training data items with respect to the predetermined perspective is reduced.

### BACKGROUND OF THE INVENTION

### Field of the Invention

The present invention relates to learning processing based on training data.

### Description of the Related Art

In recent years, research on deep learning, including convolutional neural networks (CNNs), is advancing, and with improvements in implementation techniques, processing speeds, and more, many applications are being made with respect to real-world problems. At present, many applications are being developed for image recognition, voice recognition, text recognition, and more using machine learning models that can be used in the cloud, in embedded devices, and in PCs. In general, for pattern recognition tasks (in image recognition, tasks such as image classification, object detection, semantic region segmentation, and the like), training data and validation data are prepared for each task. If there is unevenness in the variation of training images and ground truth labels in the training data, sufficiently good performance cannot be achieved when evaluating accuracy using the validation data.

Japanese Patent Laid-Open No. 2010-204966 (Patent Document 1) discloses a method for reducing unevenness in the number of pieces of data per class included in training data such that even when there are three or more types (classes) of ground truth labels included in the training data, discrimination results for classes from learning are not biased toward a particular class. Japanese Patent No. 6567488 (Patent Document 2) discloses a method for obtaining high identification accuracy even for attributes having a small number of pieces of data in training data when training an identification model that estimates attributes, which are ground truth labels, from features of target data. Specifically, the identification model is trained in a state where a number of pieces of data for attributes that do not have a maximum number of pieces of data are replicated and increased until reaching the number of pieces of data for the attribute having the maximum number of pieces of data.

However, although the conventional techniques reduce data unevenness by focusing only on the number of ground truth labels, these techniques may not necessarily be capable of reducing data unevenness when applied to tasks such as semantic region segmentation. Here, “semantic region segmentation” is a task of cropping regions of various classes (people, automobiles, roads, buildings, plants, the sky, and so on) from an image. For example, when using the method of Patent Document 1, unevenness in the number of pieces of data between classes will be reduced, but unevenness in shape variation will not necessarily be reduced. Additionally, when using the method of Patent Document 2, unevenness in the number of pieces of data between attributes will be reduced, but unevenness in shape variation will not necessarily be reduced. When these methods are applied to a task such as semantic region segmentation, appropriate learning cannot be performed. As a result, image processing based on the learning results also cannot be performed appropriately.

### SUMMARY OF THE INVENTION

According to one aspect of the present invention, a learning apparatus that trains an estimator that executes a recognition task, the learning apparatus comprises: an obtaining unit configured to obtain a plurality of training data items including input data and supervisory data corresponding to the input data; a calculating unit configured to calculate statistic information relating to a predetermined perspective in the plurality of training data items obtained by the obtaining unit; a determining unit configured to determine a degree of importance of each training data item included in the plurality of training data items based on the statistic information; and a control unit configured to control training of the estimator based on the degree of importance determined by the determining unit, wherein the determining unit determines the degree of importance of each training data item such that unevenness of the plurality of training data items with respect to the predetermined perspective is reduced.

The present invention performs learning appropriately even when unevenness is present in data contained in a training data set.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIGS. 1A to 1C are block diagrams illustrating the functional configuration of respective apparatuses.

FIGS. 2A to 2H are flowcharts illustrating processing executed by each of apparatuses.

FIG. 3 is a diagram illustrating training images and supervisory information (class labels).

FIGS. 4A and 4B are diagrams illustrating the network structure of a CNN.

FIGS. 5A to 5C are diagrams illustrating histograms of class mixing ratios of identification images.

FIGS. 6A to 6C are diagrams illustrating sizes of receptive fields of a CNN and sizes of identification images.

FIGS. 7A to 7C are diagrams illustrating examples of frequencies, correction coefficients, and data padding amounts corresponding to class mixing ratios.

FIGS. 8A to 8D are diagrams illustrating examples of using orientation information in identification images.

FIG. 9 is a diagram illustrating an example of the calculation of orientation information.

FIG. 10 is a diagram illustrating an example of class labels separated into subcategories.

FIGS. 11A to 11D are diagrams illustrating examples of the distribution of frequencies by subcategory.

FIGS. 12A and 12B are diagrams illustrating examples of correction coefficients based on class mixing ratio and Bv value.

FIGS. 13A to 13C are flowcharts illustrating processing according to a fourth embodiment.

FIG. 14 is a diagram illustrating the hardware configuration of a computer.

FIGS. 15A to 15E are flowcharts illustrating processing according to a fifth embodiment.

FIGS. 16A to 16F are diagrams illustrating training data in an object detection task.

FIGS. 17A to 17F are diagrams illustrating examples of correction coefficients corresponding to statistic information.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

Overview

In data used for training in tasks such as semantic region segmentation, it is necessary to reduce unevenness in the number of pieces of data for ground truth labels as well as unevenness regarding variations in the shapes included in the training data. Specifically, it is necessary to homogenize the data such that there is no unevenness in the data, from complex to simple shapes.

In a region detection task, which detects regions of various classes (people, automobiles, roads, buildings, plants, sky, and the like) from an images, these regions are cropped along the boundaries between one target object and a different target object. Ground truth labels, which indicate the region of the target object, are assigned in units of pixels for the target object in the image, and can take on various shapes depending on the target object to be detected. For this reason, variation in the shapes of target objects in the training data is important in semantic region segmentation tasks.

Accordingly, a first embodiment will describe a method that reduces unevenness in the number of pieces of data for ground truth labels as well as unevenness with respect to variation in shapes included in training data. Specifically, a learning apparatus that learns by homogenizing data such that there is no unevenness in the data, from complex to simple shapes, will be described. An image processing apparatus that uses the learning results will also be described.

Apparatus Configuration

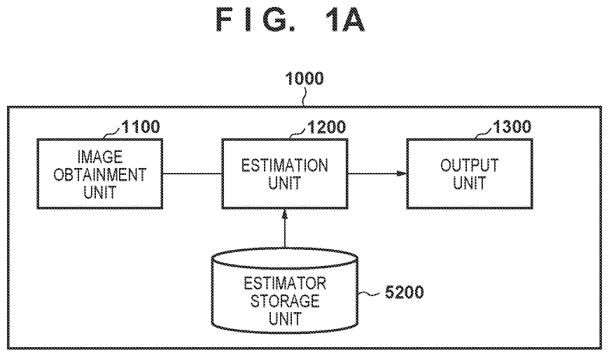

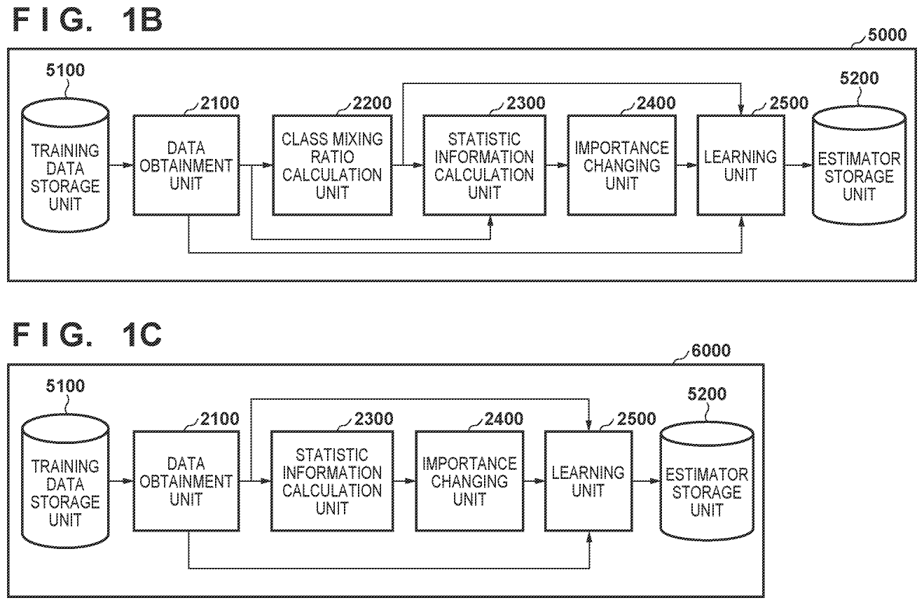

First, the functional configuration and the hardware configuration of an image processing apparatus 1000 and a learning apparatus 5000 will be described with reference to FIGS. 1A, 1B, and 14. Each functional unit illustrated in FIGS. 1A and 1B may be realized by a computer executing a software program, or by dedicated hardware. Although the image processing apparatus 1000 and the learning apparatus 5000 will be described separately, these apparatuses may be configured to realize the functions of both apparatuses on the same apparatus (computer).

Functional Configuration as Image Processing Apparatus

FIG. 1A is a block diagram illustrating the functional configuration of the image processing apparatus 1000. The image processing apparatus 1000 performs processing of estimating a mixing state of classes of a particular target object in an unknown input image.

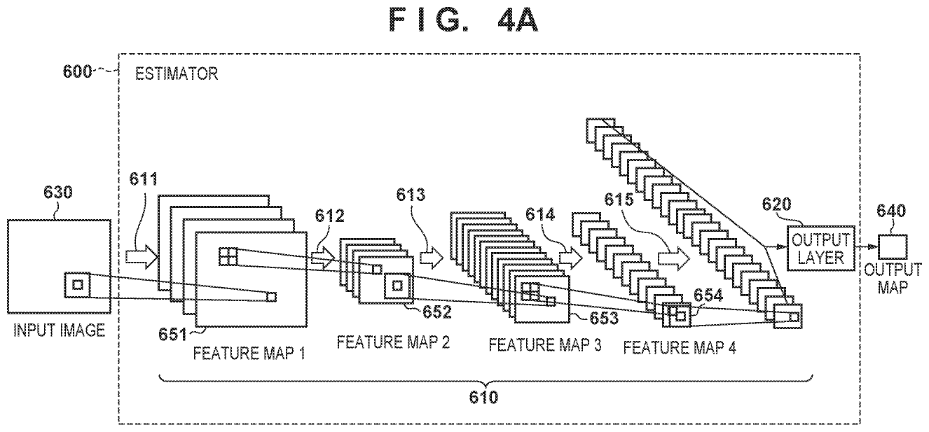

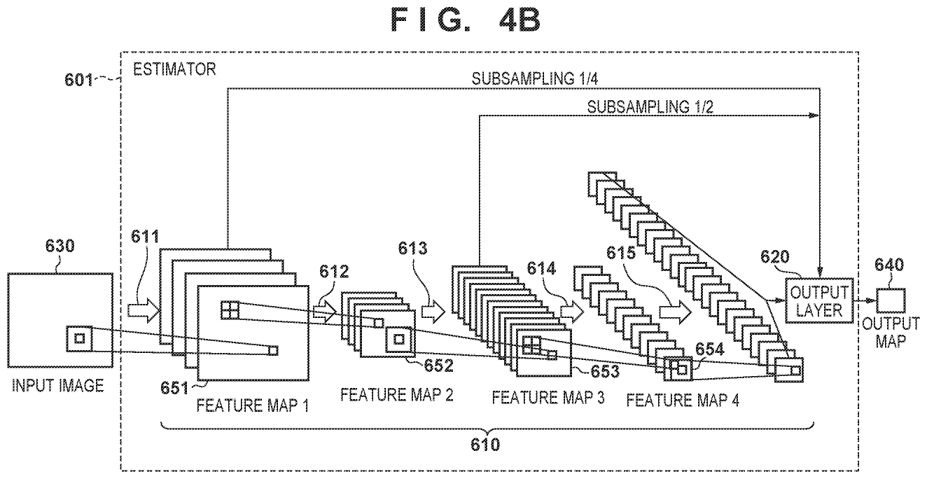

An image obtainment unit 1100 obtains input images. An estimation unit 1200 uses an estimator 600, which will be described later with reference to FIG. 4A, to estimate the mixing state of the classes for each of identification images in the input image, and outputs a result to an output unit 1300. The estimator 600 has been pre-trained by the learning apparatus 5000. Learned parameters are stored in an estimator storage unit 5200, and by reading the parameters from the estimator storage unit 5200, the estimator 600 enters a state of being capable of estimating the mixing state of the classes. The output unit 1300 outputs an estimation result from the estimation unit 1200.

The image obtainment unit 1100, the estimation unit 1200, and the output unit 1300 may be implemented in the same computer, or may be configured as independent modules. These may also be implemented as programs that run on the computer. These may also be implemented as circuitry or programs inside an image capturing apparatus such as a camera or the like.

Functional Configuration as Learning Apparatus

FIG. 1B is a block diagram illustrating the functional configuration of the learning apparatus 5000. The learning apparatus 5000 generates the estimator, which is used by the image processing apparatus 1000 in processing for recognizing the mixing state of the classes, from training data prepared in advance.

A training data storage unit 5100 stores the training data prepared in advance. The training data includes training images and supervisory information. A data obtainment unit 2100 obtains the training data from the training data storage unit 5100. A class mixing ratio calculation unit 2200 calculates class mixing ratio supervisory information for each identification image from class label supervisory information input for each pixel. This will be described in detail later with reference to FIG. 3.

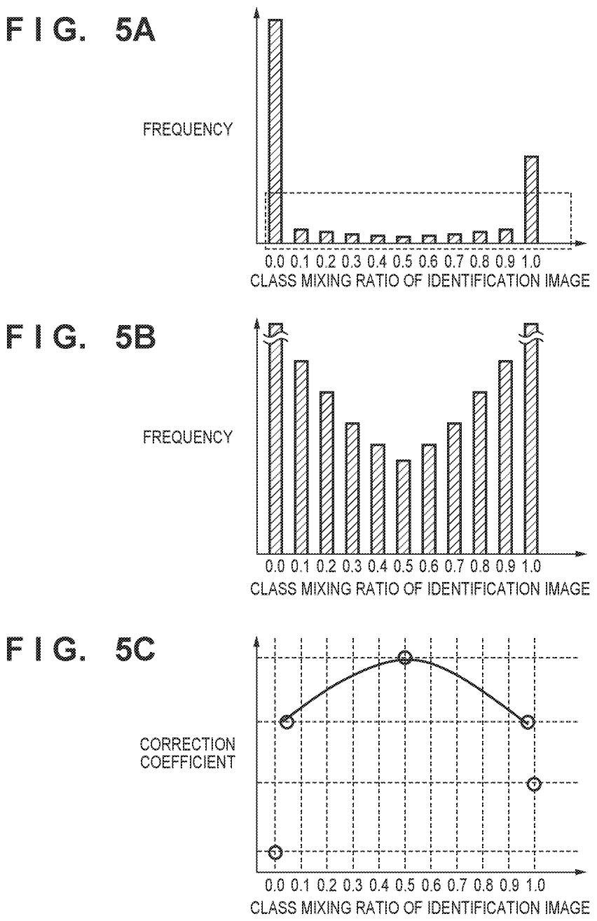

A statistic information calculation unit 2300 calculates statistic information pertaining to a predetermined perspective to ascertain unevenness of the training data, based on the training images, the supervisory information, and the supervisory information of the class mixing ratio for each identification image. Here, the statistic information calculation unit 2300 calculates the class mixing ratio for a range including the periphery of the identification image. This will be described in detail later with reference to FIGS. 5A and 5B.

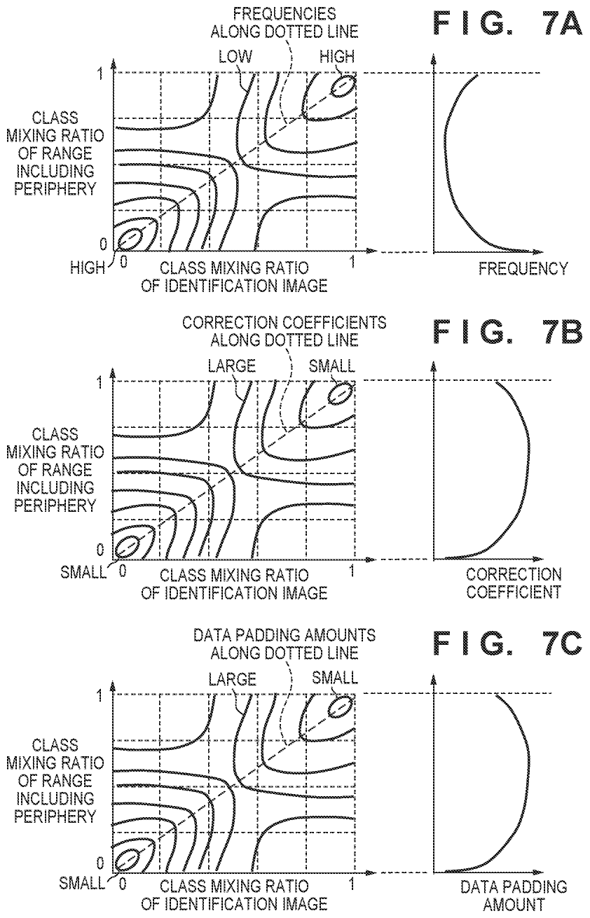

An importance changing unit 2400 changes a degree of importance during learning for each piece of the training data based on the statistic information calculated by the statistic information calculation unit 2300. This will be described in detail later with reference to FIGS. 7A and 7B.

A learning unit 2500 uses the training images, the supervisory information, and the degree of importance thereof to perform learning for the estimator 600, which will be described later with reference to FIG. 4A. Parameters of the estimator 600 obtained from the training are stored in the estimator storage unit 5200. The estimator storage unit 5200 can store the parameters of the estimator 600 determined through the training.

The data obtainment unit 2100, the class mixing ratio calculation unit 2200, the statistic information calculation unit 2300, the importance changing unit 2400, and the learning unit 2500 may be implemented in the same computer, or may be configured as independent modules. These may also be implemented as programs that run on the computer. The training data storage unit 5100 and the estimator storage unit 5200 of the learning apparatus can be realized using storage inside or outside the computer.

The image processing apparatus 1000 and the learning apparatus 5000 described above may be realized on the same computer, or on separate computers. The estimator storage units 5200 provided in the learning apparatus 5000 and the image processing apparatus 1000 may be the same storage, or may be different storage. When different storage is used, the estimator stored in the estimator storage unit 5200 by the learning apparatus is assumed to be copied or moved to the estimator storage unit 5200 provided in the image processing apparatus.

Hardware Configuration

FIG. 14 is a diagram illustrating the hardware configuration of a computer that realizes the image processing apparatus 1000 and the learning apparatus 5000 by executing software programs.

A processor 101 is a CPU, for example, and controls the operations of the computer as a whole. Memory 102 is RAM, for example, and temporarily stores programs, data, and the like. A computer-readable storage medium 103 is, for example, a hard disk, a CD-ROM, or the like, and stores programs, data, and the like on a long-term basis. In the present embodiment, programs that realize the functions of each unit, which are stored by the storage medium 103, are read out to the memory 102. Then, the processor 101 operates according to the programs in the memory 102 to realize the functions of each unit.

An input interface 104 is an interface for obtaining information from an external apparatus. An output interface 105 is an interface for outputting information to an external apparatus. A bus 106 connects the various units described above to enable the exchange of data.

Apparatus Operations

The present embodiment will describe a semantic region segmentation task using a CNN as an example. As described in the Description of the Related Art, “semantic region segmentation” is a task of cropping regions of various classes from an image, such as people, automobiles, plants, sky, and the like. The present embodiment assumes the use of a method for recognizing a mixing state of classes in a partial region image (an identification image) in a captured image, as described in Japanese Patent Laid-Open No. 2019-16114.

Operations as Image Processing Apparatus

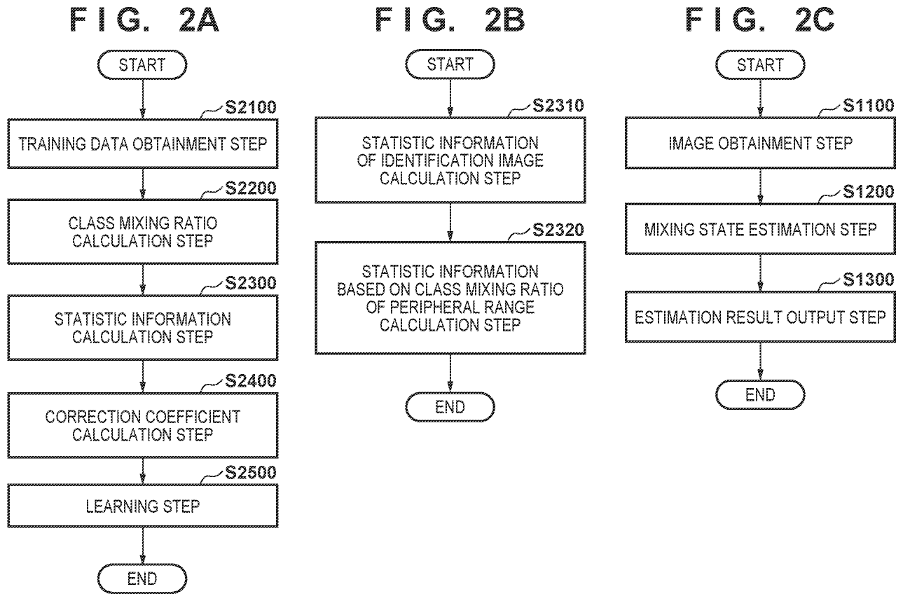

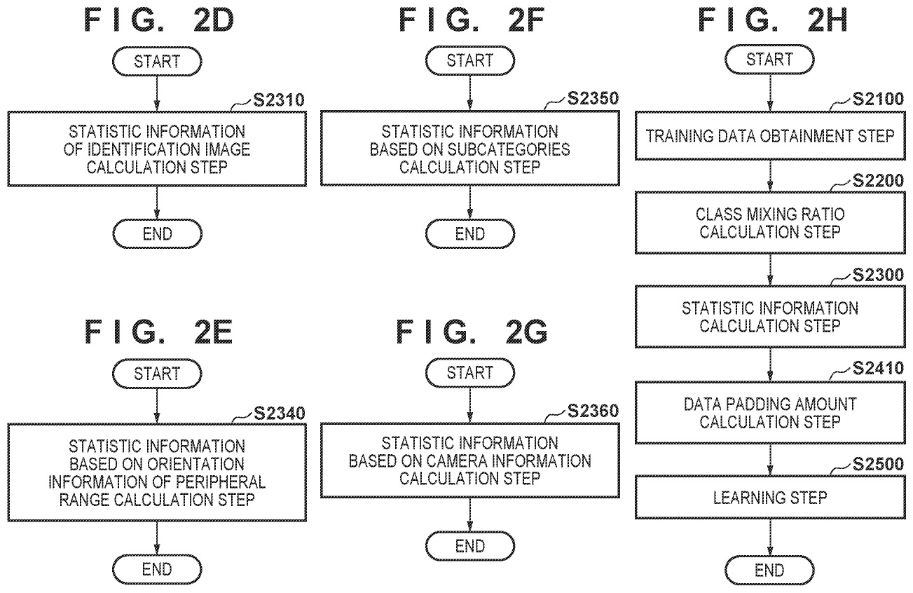

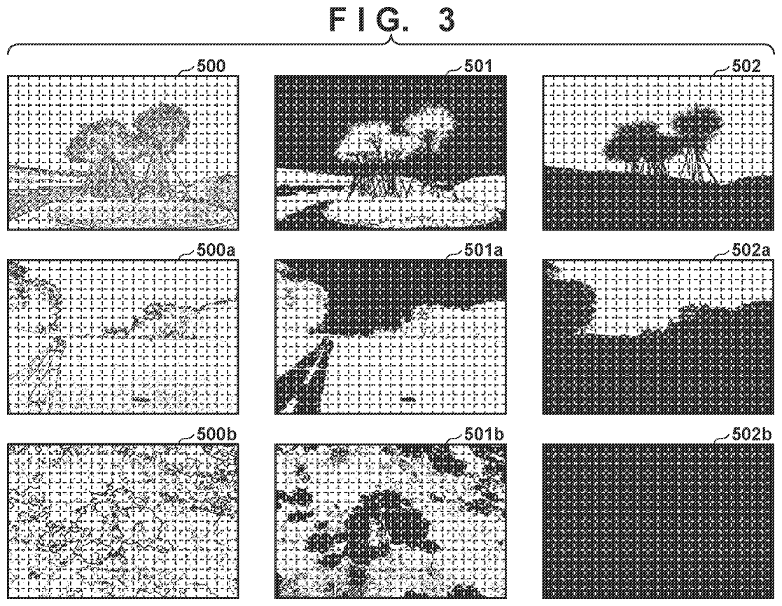

FIG. 2C is a flowchart illustrating processing executed by the image processing apparatus 1000. The image processing apparatus 1000 performs processing of estimating the mixing state of an input image. The estimator used by the image processing apparatus 1000 is assumed to have been pre-trained through learning processing (FIG. 2A) performed by the learning apparatus 5000, which will be described later.

In step S1100, the image obtainment unit 1100 obtains the input image for which the mixing state is to be estimated. The image obtainment unit 1100 can also obtain image data before development, obtained from an image capturing apparatus.

The image obtainment unit 1100 sets a plurality of partial regions for which the mixing state is to be estimated at predetermined positions in the input image according to a predetermined setting pattern. An image of this partial region will be called an “identification image” hereinafter. Although details will be given later, the identification image is a partial image of a predetermined size according to a unit of identification, such as a 4×4 pixel rectangular partial image, for example, and the setting method thereof is not particularly limited.

In step S1200, the estimation unit 1200 loads, from the estimator storage unit 5200, an estimator that has been pre-trained by the learning apparatus described later. 600 in FIG. 4A indicates an example of using a CNN as the estimator. The estimation unit 1200 extracts features from the input image obtained in step S1100 using a feature extraction unit 610 indicated in FIG. 4A. The extracted features are input from the feature extraction unit 610 to an output layer 620, and information indicating the mixing state of classes in the identification image is generated as a result. Although an example of using a CNN as the estimator is described here, various identification methods based on machine learning, such as SVM and Randomized Tree, can be used.

Various forms can be used as the configuration of the CNN. Typically, a CNN is a neural network that performs recognition tasks by gradually collecting local features of an input signal by iterating through convolutional layers and pooling layers to obtain information that is robust with respect to deformation, misalignment, and the like. For example, the CNNs described in Document A can be used.

Document A: A. Krizhevsky et al., “ImageNet Classification with Deep Convolutional Neural Networks”, Proc. Advances in Neural Information Processing Systems 25 (NIPS 2012).

FIG. 4A illustrates the network structure of the CNN included in the estimator 600. To simplify the descriptions, the present embodiment will describe a CNN having a relatively simple structure as the estimator 600, but CNNs having more complex structures are applicable as well. The estimator 600 is constituted by the feature extraction unit 610 and the output layer 620.

The feature extraction unit 610 is constituted by a plurality of convolutional layers (a layer 611, a layer 613, and a layer 615) and a plurality of pooling layers (a layer 612 and a layer 614), and extracts features from an input image 630.

In the convolutional layer, a plurality of channels of filters of sizes such as 3×3 or 5×5 are set for the input image or a feature map, and for convolution operations are performed centered on a pixel of interest to output a plurality of feature maps corresponding to the plurality of channels. Here, a convolutional layer 1 (the layer 611) has four channels with a filter size of 3×3, a convolutional layer 2 (the layer 613) has 12 channels with a filter size of 3×3, and a convolutional layer 3 (the layer 615) has 24 channels with a filter size of 3×3.

The pooling layers reduce the feature map output from the convolutional layers. If pooling is performed in a 2×2 range, the feature map is reduced by a factor of ½×½. Methods such as maximum value pooling and average value pooling can be used. Here, a pooling layer 1 (the layer 612) and a pooling layer 2 (the layer 614) both perform pooling in a 2×2 range. In the example in FIG. 4A, there are two pooling layers in the 2×2 range, and thus the resolution of the input image 630 is reduced by a factor of ¼×¼ at the output map stage.

The output layer 620 generates an output map 640, which is information indicating the mixing state of classes in the identification image based on the features obtained from the feature extraction unit 610.

The network structure of the CNN is not limited to that illustrated in FIG. 4A. A network structure such as an estimator 601 illustrated in FIG. 4B, which is configured such that an intermediate feature map 1 (a map 651) and feature map 3 (a map 653) are input to the output layer 620, can also be used. The CNN can also have more layers than that illustrated in FIG. 4A, and the number of channels may be changed.

In step S1300, the output unit 1300 outputs the estimation result obtained in step S1200. The processing performed by the output unit 1300 depends on the method for using the estimation result, and is not particularly limited. Information indicating the mixing state can be used for various processing, such as image correction, focus control, exposure control, and the like, as described in Document B.

Document B: O. Ronneberger et al., “U-Net: Convolutional Networks for Biomedical Image Segmentation”, International Conference on Medical Image Computing and Computer-Assisted Intervention (MICCAI), 2015

### Operations as Learning Apparatus

FIG. 2A is a flowchart illustrating learning processing executed by the learning apparatus 5000.

In step S2100, the data obtainment unit 2100 obtains the training images and the supervisory information pertaining to the region as the training data from the training data storage unit 5100. The training data storage unit 5100 stores, in advance, a plurality of training images as well as information associated with the training images, such as supervisory information pertaining to the region and the camera parameters at the time of shooting.

“Training images” are images used to train the estimator. The training image can be, for example, image data captured by a digital camera or the like. The format of the image data is not particularly limited and can be, for example, JPEG, PNG, BMP, or the like. In the following, the number of prepared training images is assumed to be N, and an nth training image is denoted as In (where n=1, . . . , N).

The supervisory information pertaining to the region is the input class information for each pixel of the training image. This supervisory information is prepared in advance and can be created, for example, by a human looking at the training images.

FIG. 3 is a diagram illustrating training images and supervisory information (class labels). A subject in an image can be classified into a plurality of regions. FIG. 3 illustrates an example of such classification into classes.

A training image 500 contains trees (plants) in a central part of the image, grass (plants) in a bottom part of the screen, and sky in a top part of the screen, each of which can be classified into a different class. Supervisory information 501 indicates the class labels for the “plant” region corresponding to the training image 500, and a class label is created for each pixel of the training image. White regions in the image represent regions where plants are present, and black regions represent regions where plants are absent (non-plant regions). Meanwhile, supervisory information 502 indicates the class labels for the “sky” region corresponding to the training image 500, and a class label is created for each pixel of the training image. White regions in the image represent regions where sky is present, and black regions represent regions where sky is absent (non-sky regions).

A region of a person's entire body, a region of a person's skin, a region of a person's hair, a region of an animal such as a dog, a cat, or the like, an artificial object such as an automobile or a building, and the like can be given as examples of class labels aside from “plant” and “sky”. Class labels can also be used to indicate specific objects, such as component A or component B used in a factory. In addition, each pixel may be classified into a main subject region and a background region. The classification may also be performed based on differences in surface properties, such as glossy surfaces or matte surfaces, or on differences in materials, such as metal surfaces or plastic surfaces.

A training image 500a contains grass (plants) in the bottom part of the screen, trees (plants) in the upper-left and right-center of the screen, and sky in a top part of the screen. Supervisory information 501a is supervisory information for the “plant” region, and supervisory information 502a is the supervisory information for the “sky” region.

A training image 500b is an image that contains only flowers (plants) throughout. Supervisory information 501b is supervisory information for the “plant” region, and supervisory information 502b is the supervisory information for the “sky” region. Note that because the training image 500b does not contain any “sky” regions, the entirety thereof is an image with black regions.

The present embodiment will describe an example of a task that identifies two classes, namely a “plant region” class, and a “non-plant region” class that represents regions aside from plant regions. Note that information accompanying the training image, such as camera parameters at the time of shooting, is not used in the first embodiment, but will be described in detail later in a third embodiment.

In step S2200, the class mixing ratio calculation unit 2200 calculates supervisory information of the mixing state of classes in predetermined units of identification images from the supervisory information of class labels for each pixel, obtained from the data obtainment unit 2100 in step S2100. In the present embodiment, the identification image is set as a 4×4-pixel rectangular partial image.

The method for setting the identification image is not particularly limited. For example, a plurality of identification images can be set in the input image according to a predetermined setting pattern. As a specific example, the training image can be divided into a plurality of rectangular partial images of a predetermined size (e.g., 4×4 pixels) and each rectangular partial image can be treated as an identification image. The method described in Document C can also be used to divide the image into irregularly-shaped small regions (superpixels) and treat each small region as an identification image.

Document C: R. Achanta et al., “SLIC Superpixels”, EPFL Technical Report 149300, 2010.

FIG. 3 illustrates an example of dividing the training images 500, 500a, and 500b into rectangular partial images of 22 horizontal blocks×16 vertical blocks. The rectangular partial images separated by dotted lines correspond to the identification images. In step S2200, a class mixing ratio is calculated for each of the identification images at a value between 0.0 and 1.0. This value corresponds to the area ratio of plant regions indicated by white and non-plant regions indicated by black in the supervisory information 501, 501a, and 501b. For example, in a 4×4 pixel identification image, if the plant region is 12 pixels and the non-plant region is 4 pixels, a class mixing ratio r for the plant class is r=12 pixels/16 pixels=0.75.

In step S2300, the statistic information calculation unit 2300 calculates the statistic information based on the class mixing ratio information obtained from the class mixing ratio calculation unit 2200. The specific flow of the processing in step S2300 is illustrated in FIG. 2B.

In step S2310, the statistic information calculation unit 2300 calculates the statistic information of the identification image. Specifically, the statistic information is calculated based on the value of the class mixing ratio for all identification images (within the partial regions) for all N training images. In the present embodiment, the training image is divided into identification images of 22 horizontal blocks×16 vertical blocks, and thus an identification image of 352 blocks is created for each image. This applies to the N images, and thus the total amount of information is N×352 blocks.

FIG. 5A illustrates the class mixing ratios in all N training images for all identification images as histograms. Because the majority of identification images have a class mixing ratio of 0 or 1, the frequency of bins at both ends, which contain those two values, is high. On the other hand, the frequency of identification images having intermediate values not included in the bins at both ends is low, and thus the frequency of bins having intermediate values is also low.

As can be seen by referring to the supervisory information 501, 501a and 501b, in the identification images delimited by the rectangles, plant regions at 100% (class mixing ratio=1) and plant regions at 0% (class mixing ratio=0) make up the majority. The training data includes many images in which plant regions do not exist (negative data) to prevent false positives in regions where plants do not exist, the number of pieces of data in which the class mixing ratio=0 is particularly high.

The class mixing ratio takes an intermediate value (a value greater than 0 and less than 1) when the identification image is a boundary part between a plant region and a non-plant region, or when plant regions and non-plant regions (e.g., sky) are mixed together, such as the leaves of plants. The frequency at which such identification images occur is relatively low.

FIG. 5B is an enlarged image of the area surrounded by the dotted line in FIG. 5A with respect to the vertical direction (frequency). The frequency at which the class mixing ratio takes on an intermediate value has, for example, a shape similar to a downward convex quadratic function. However, the histogram shape depends on the training data.

As illustrated in FIGS. 5A and 5B, the frequency of class mixing ratios is uneven. When training is performed with such unevenness present, identification images having a class mixing ratio of 0 or 1, where there is a large amount of data, are appropriately learned. On the other hand, identification images having class mixing ratios which are intermediate values, where there is a small amount of data, are not appropriately learned. This worsens the accuracy of estimation for intermediate values.

In step S2320, the statistic information calculation unit 2300 calculates the class mixing ratio in the range including the information in the periphery of the identification image. As in step S2310, the values of the class mixing ratios for all N identification images in the training image are calculated. The reason for calculating the class mixing ratio within a range that includes the information in the periphery will be described below.

The class mixing ratio of the identification images corresponds to the output result of the CNN (a response variable). The information input to the CNN to produce the output result (an explaining variable) is information from a broader range. Accordingly, by understanding not only the statistic information of the supervisory information corresponding to the output result, but also the statistic information of the supervisory information in a range corresponding to the information input to the CNN, unevenness in the variation of the training images can be evaluated more correctly.

For example, when the class mixing ratio of a given identification image is high and the image is filled with plant regions, there is a strong trend that the class mixing ratio will also be high in the periphery of the identification image. Such cases occur frequently. On the other hand, in the case of isolated plants, the class mixing ratio of the identification image will be high, but the class mixing ratios in the periphery thereof will be low. Such cases occur infrequently. Unevenness in the variation of such data cannot be grasped simply by grasping the class mixing ratio of the identification image. Accordingly, by grasping the class mixing ratio of a range including the periphery of the identification image in addition to the class mixing ratio of the identification image, unevenness in the variation of the data can be appropriately grasped and reflected in the learning.

The range of information input to the CNN will be described next. As described earlier, in the present embodiment, the estimation processing is performed using the CNN illustrated in FIG. 4A. In such a network structure, where convolutional layers and pooling layers are repeated in multiple stages, the class mixing ratio is obtained using information of pixels in the periphery when calculating the class mixing ratio of a target identification image.

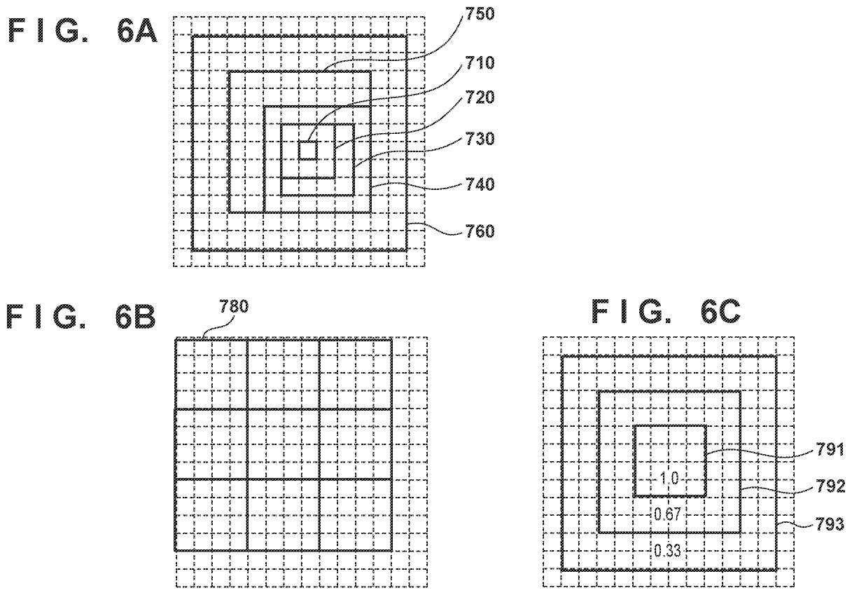

FIGS. 6A to 6C are diagrams illustrating sizes of receptive fields of the CNN and sizes of the identification images.

If a region 710 in FIG. 6A is taken as a pixel of interest, the receptive field for the convolutional layer 1 is a 3×3 range indicated by a region 720. Next, the receptive field for the pooling layer 1 is a 4×4 range indicated by a region 730. In this manner, the receptive field is gradually expanded by the convolutional layers and the pooling layers, and ultimately expands to a 12×12 range indicated by a region 760 in FIG. 6A. In other words, with the network structure illustrated in FIG. 4A, the class mixing ratio is obtained using information of a range of 12 pixels×12 pixels, indicated by the region 760. Although FIG. 6B illustrates a range of 4 pixels×4 pixels for the identification image, a range which takes into account the receptive field corresponds to 9 times the area of the identification image.

When obtaining the class mixing ratio of a range including information from the periphery as well, there is a method which obtains a uniform average value for all the peripheral pixels, and a method which obtains a weighted average value which is weighted such that values increase with proximity to the center. When an input image is input to the CNN, information at earlier stages of the CNN is added more frequently, and thus finding an average such that values increase with proximity to the center can be said to make it possible to calculate an average value more in line with the operations of the CNN.

Specifically, as illustrated in FIG. 6C, the supervisory data within the rectangle indicated by a region 791 is multiplied by 1.0. The supervisory data inside the rectangle indicated by a region 792 but outside the rectangle indicated by the region 791 is multiplied by 0.67. The supervisory data inside the rectangle indicated by a region 793 but outside the rectangle indicated by the region 792 is multiplied by 0.33. By adding each of these and then dividing by the value obtained when all the supervisory data is 1, a class mixing ratio having a value from 0 to 1 can be obtained.

FIG. 7A illustrates an example of a graph in which the class mixing ratio for the identification image obtained in step S2310 (horizontal axis) and the class mixing ratio of the range including the information of the periphery obtained in step S2320 (vertical axis) are shown two-dimensionally. The distribution is such that there is a frequency peak in the lower-left and the upper-right parts of the graph, and the frequency decreases toward the center of the graph. The distribution is also such that there is a minimum value for the frequency in the upper-left and the lower-right parts of the graph.

A graph in which the frequencies are plotted along a dotted line connecting the lower-left and the upper-right of the above-described graph (the left side of FIG. 7A) is indicated on the right side of FIG. 7A. It can be seen that there are high frequencies at the starting point and the ending point of the graph, and that the frequency near the center is low.

In step S2400, the importance changing unit 2400 obtains a correction coefficient based on the statistic information obtained from the statistic information calculation unit 2300. This correction coefficient is used when optimizing weighting coefficients of the CNN using error back propagation in step S2500, described later. A higher correction coefficient indicates a greater contribution to the learning, whereas a lower correction coefficient indicates a smaller contribution to the learning. In other words, controlling the correction coefficient makes it possible to change the degree of importance of the data in the learning.

Accordingly, by increasing the correction coefficient for data having a low frequency of occurrence in FIG. 7A and reducing the correction coefficient for data having a high frequency of occurrence, unevenness in the variation of the data is reduced. Specifically, when DMAX represents the frequency that appears most frequently in FIG. 7A, a correction coefficient Ci for data having a frequency of Di is calculated using, for example, Formula (1).

Ci=α×DMAX/Di (1)

α is a hyperparameter. i represents the ID of the histogram bin, and if the total number of bins is I, correction coefficients are calculated in the range i=1 to I, respectively. The magnitude of the correction coefficient is inversely proportional to the frequency of occurrence, such that the coefficient is lower when the frequency is higher, and the coefficient is higher when the frequency is lower.

The left side of FIG. 7B indicates an example of the correction coefficient. The distribution is such that minimum values the correction coefficient are present at lower-left and upper-right parts of the graph, and the value of the correction coefficient increases with proximity to the center of the graph. The distribution is also such that there is a peak in the upper-left and the lower-right parts of the graph. By comparing the graph on the left side of FIG. 7A with the graph on the left side of FIG. 7B, it can be seen that as the frequency of occurrence decreases, the correction coefficient increases.

A graph in which the correction coefficients are plotted along a dotted line connecting the lower-left and the upper-right of the above-described graph (the left side of FIG. 7B) is indicated on the right side of FIG. 7B. It can be seen that the correction coefficient is low at the starting point and the ending point of the graph, and the correction coefficient is high near the center.

In step S2500, the learning unit 2500 performs learning based on the training image obtained from the data obtainment unit 2100, the supervisory information expressing the class mixing state obtained from the class mixing ratio calculation unit 2200, and the correction coefficient obtained from the importance changing unit 2400. More specifically, the learning unit 2500 learns the parameters of the feature extraction unit 610 and the output layer 620 of the estimator 600 indicated in FIG. 4A.

As described earlier, in the convolutional layers of the CNN, a convolution operation is performed on the input image 630, using a filter of a predetermined size and centered on a pixel of interest, and a feature map is output. For the number of channels, the filter size is 3×3, for four channels, in the convolutional layer 1 (the layer 611) in FIG. 4A; the filter size is 3×3, for 12 channels, in the convolutional layer 2 (the layer 613); and the filter size is 3×3, for 24 channels, in the convolutional layer 3 (the layer 615). The learning unit 2500 learns filter coefficients of this 3×3 size filter as parameters for the feature extraction unit 610.

When performing learning for the estimator 600, the learning unit 2500 compares a supervisory signal with the value of an output signal obtained from the output layer 620 when an identification image obtained from a predetermined position j of a training image In is input to the CNN, and obtains error. The CNN can be trained by sequentially back propagating the error obtained in this manner from the output layer to the input layer using error back propagation. As the initial values for the weighting coefficients of the CNN, random values can be used, or weighting coefficients obtained from learning related to some task may be used.

When sequentially back propagating error from the output layer to the input layer using error back propagation, changing the correction coefficient for each identification image makes it possible to control the contribution to the learning. The following will describe an example of controlling the contribution using the correction coefficient.

Assume that Xⁿⱼ represents the feature obtained by inputting, to the feature extraction unit 610, the identification image obtained from the predetermined position j in the training image In, and y(Xⁿⱼ) represents the output signal obtained by inputting this to the output layer 620. Additionally, of the output map 640, the supervisory data corresponding to the predetermined position j is represented by Tⁿⱼ. In this case, error E between the output signal and the supervisory information is calculated as indicated by Formula (2).

E(n,j)=(y(Xⁿⱼ)−Tⁿⱼ) (2)

Assuming that the correction coefficient of the identification image obtained from the predetermined position j in the training image In is Cⁿⱼ, error Ec which takes into account the correction coefficient is calculated as indicated by Formula (3).

Ec(n,j)=Cⁿⱼ×E(n,j) (3)

The relationship between the correction coefficient Ci by the bin ID and the correction coefficient that is Cⁿⱼ for the identification image is determined in advance. Although Formula (3) indicates an example of multiplying the correction coefficient by the error, other operations, such as using addition, may be used instead.

As described earlier with reference to step S2400, when there is unevenness in the variation of the data, the contribution is increased for relatively small data numbers, and the contribution is reduced for relatively large data numbers. The correction coefficient may be increased to increase the contribution, and the correction coefficient may be reduced to reduce the contribution. In the learning unit, error back propagation is performed by referring to the value of the correction coefficient calculated for each identification image in step S2400.

According to the first embodiment described thus far, a statistic amount is obtained by taking into consideration not only the class mixing ratio of the identification image, but the class mixing ratio and a range including the periphery of the identification image. Based on the obtained statistic amount, the correction coefficient is increased for relatively large numbers of data, and the correction coefficient is reduced for relatively small numbers of data. Through this, learning can be performed for the estimator, taking into account unevenness in variation included in the training data.

The recognition accuracy for a variety of target objects can be improved by reducing not only unevenness in the number of data between classes, attributes, and the like of the training data, but also unevenness in the variation of the training data within the same class, the same attribute, and so on.

Although the first embodiment describes an example of application to a semantic region segmentation task, the embodiment is applicable to other tasks as well. For example, the embodiment can be applied to other tasks such as object detection, scene recognition, and the like.

First Variation

In the first embodiment, unevenness in the variation of the training data is calculated using two indicators, namely the class mixing ratio of the identification image and the class mixing ratio of a range including the identification image and the periphery thereof. In a first variation, the variation of data is evaluated based on orientation information, i.e., in which direction class labels are more prevalent, in a range including the identification image and the periphery thereof.

The functional configuration of the learning apparatus 5000 according to the first variation is similar to that in FIG. 1A, but the details of the statistic information calculation unit 2300 and the importance changing unit 2400 are different from those of the first embodiment. The functional configuration of the image processing apparatus 1000 according to the first variation is similar to that in the first embodiment, and will therefore not be described.

Although the processing flow according to the first variation is similar to that in FIG. 2A, the details of steps S2300, S2400, and S2500 are different.

Step S2300 includes step S2320, and the statistic information calculation unit 2300 calculates the statistic information based on orientation information of the class label data in a peripheral range of the identification image. The specific flow of the processing in step S2300 is illustrated in FIG. 2E.

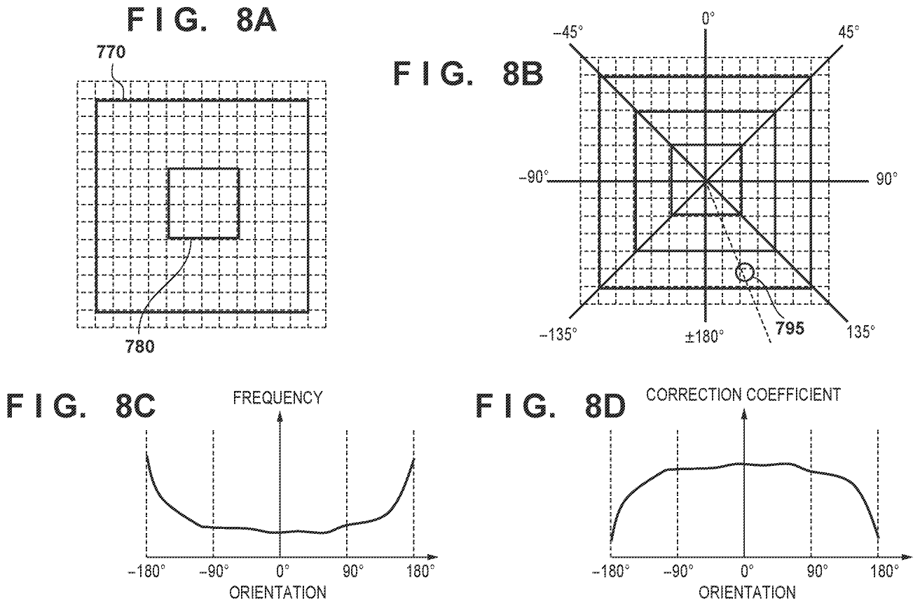

FIGS. 8A to 8D are diagrams illustrating the usage of orientation information and identification images. First, a peripheral range is determined for each identification image, as illustrated in FIG. 8A. The size of the peripheral range can be set as desired, and may be set, for example, to be equal to the size of the receptive field of the CNN. The size of the peripheral range may be any size for which the orientation information can be correctly obtained based on a center of gravity position, and as long as that condition is satisfied, may be the same size as the size of the identification image, larger than the size of the identification image, or smaller than the size of the receptive field.

Next, a center of gravity position of the label is obtained for each class within the peripheral range. Note that when obtaining the center of gravity position for the label, the weight may be increased with proximity to the center, as illustrated in FIG. 6C. Next, the orientation information is obtained based on the center of gravity position.

FIG. 8B is a diagram illustrating an example of the calculation. Focusing on a given identification image, assume that the center of gravity position of a class label in a range including the peripheral range is the position of a point 795. At this time, a line segment is drawn connecting the center position (center point) of the identification image with the point 795. As illustrated in FIG. 8B, assume that the orientation of a line extending upward from the center point is 0°. Relative to this orientation of 0°, clockwise is taken as the + direction, and counterclockwise as the − direction. Furthermore, assume that the orientation of the line extending downward from the center point (the orientation opposite to 0°) is ±180°. At this time, the orientation of a line segment connecting the center point and the point 795 is +159°.

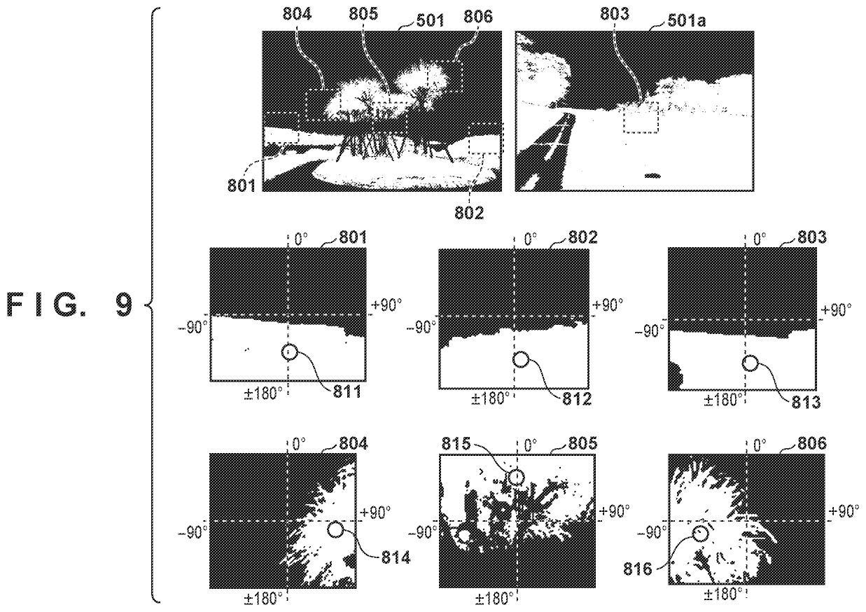

FIG. 9 is a diagram illustrating an example of the calculation of the orientation information. In other words, a specific example of obtaining the orientation information from the center of gravity position of a class label will be described. The supervisory information 501 in FIG. 9 is the same as the supervisory information 501 in FIG. 3, and indicates class labels for plant regions. Similarly, the supervisory information 501a in FIG. 9 is the same as the supervisory information 501a in FIG. 3.

Enlarged versions of the rectangular ranges surrounded by dotted lines 801 to 803 in FIG. 9 are shown in the middle of FIG. 9. The rectangular range 801 is an example of an image of a plant “grass”, and plant labels appear often in the bottom part. The center of gravity position (the center of gravity position of the regions indicated by white) is a point 811, and the orientation from the center of the rectangular range is in the vicinity of ±180°. The rectangular ranges 802 and 803 are, similar to the rectangular range 801, images of a plant “grass”, and plant labels appear often in the bottom part. The center of gravity positions are a point 812 and a point 813, respectively, and the orientations thereof are in the vicinity of ±180°.

The rectangular ranges surrounded by dotted lines 804 to 806 in FIG. 9 are examples of identification images set in the periphery of “isolated trees”, and each of these ranges is shown enlarged in the bottom of FIG. 9. The rectangular range 804 has a center of gravity position at a point 814, and the orientation thereof is in the vicinity of +90°; the rectangular range 805 has a center of gravity position at a point 815, and the orientation thereof is in the vicinity of 0°; and the rectangular range 806 has a center of gravity position at a point 816, and the orientation thereof is in the vicinity of −90°. In this manner, in the case of “isolated trees”, a variety of orientation information is obtained.

The orientation information is obtained for all the identification images in the N training images, and a distribution of the frequencies thereof is illustrated in FIG. 8C. As illustrated in FIG. 8C, relatively speaking, more class labels are assigned to the bottom parts of the rectangular range, as with images of “grass”, and few have various orientation information, as with “isolated trees”. As such, there is more data in the vicinity of an orientation of ±180°, and less data for other orientations.

In step S2400, the importance changing unit 2400 calculates the correction coefficient based on the statistic information obtained in step S2300. As illustrated in FIG. 8D, the correction coefficient is increased for orientations having lower frequencies in FIG. 8C, and the correction coefficient is reduced for orientations having higher frequencies in FIG. 8C. Formula (1) can be used when calculating the correction coefficient from the frequency.

In step S2500, the learning unit 2500 performs learning while changing the correction coefficient based on the orientation of each identification image when applying error back propagation, similar to the first embodiment. Performing control in this manner makes it possible to reduce unevenness in variation in the orientation information of the class label data.

As described thus far, and the first variation, the orientation information is obtained based on the center of gravity position of the labels, in a range including information of the periphery of the identification image. This makes it possible to reduce unevenness in variation in the orientation information of the class label data.

Second Variation

A second variation will describe a method for reducing variation in the data using statistic information on the class mixing ratios of the identification images.

In the histogram of the class mixing ratios of the identification images illustrated in FIG. 5A, the majority of the data is data having a class mixing ratio of 0.0 or 1.0. In other words, only a minority of pieces of data have other class mixing ratios. Accordingly, learning advances for class mixing ratios of 0 and 1, which is the majority of the data, but advances less easily for class mixing ratios having intermediate values. In other words, the accuracy is high when the class mixing ratio is 0 or 1, but the estimation accuracy decreases when the class mixing ratio is an intermediate value (e.g., 0.5).

Accordingly, in the first embodiment, data unevenness is reduced by increasing the correction coefficient for a minority of pieces of data, and reducing the correction coefficient for the majority of the data. However, when there is too large difference between the number of pieces of data in the majority data and the minority data, determining the correction coefficient faithfully to the ratio of the data numbers can be detrimental to the overall performance due to the following reasons.

In other words, because the distribution of validation data for performance validation tends to be generally similar to that of the training data, the majority data in the training data will also be the majority in the validation data. Accordingly, if the degree of importance of the minority data is increased faithfully according to the number of pieces of data in the training data, the performance may be degraded in the majority data occupying the majority of the validation data, resulting in lower overall performance.

Accordingly, in the second variation, the statistic information of the training data is obtained, and the ratio of the correction coefficients between the highest-frequency data and other data is made to not be excessively high. Specifically, the ratio of the correction coefficients is determined so as to be smaller than the ratio between the number of pieces of the highest-frequency training data and the number of pieces of training data with a lower occurrence frequency. This makes it possible to suppress excessively large contributions from data which does not have a maximum frequency. This in turn makes it possible to improve the performance of minority data while maintaining the performance of majority data, which affects the overall performance.

An example of the configuration of the learning apparatus 5000 according to the second variation is similar to that in FIG. 1A, but the details of the statistic information calculation unit 2300 and the importance changing unit 2400 are different from those of the first embodiment. Note that the image processing apparatus 1000 according to the second variation is similar to that in the first embodiment, and will therefore not be described.

Although the processing flow according to the second variation is similar to that described in the first embodiment with reference to FIG. 2A, the details of step S2300 are different. FIG. 2D illustrates the specific processing flow of step S2300. Step S2310 is similar to in the first embodiment. The histogram of the class mixing ratios of the identification image in the second variation is as illustrated in FIG. 5A.

In step S2400, the importance changing unit 2400 obtains the correction coefficient based on the frequency of occurrence of the identification images. The number of pieces of data in the bin containing the class mixing ratio of 0.0, which has the largest number of pieces of data, is assumed to be DMAX. At this time, the correction coefficient Ci for data having a frequency of Di is calculated through Formula (4).

Ci=βi×DMAX/Di (4)

βi<1.0 (5)

βi in Formula (5) is a hyperparameter. i represents the ID of the histogram bin, and if the total number of bins is I, correction coefficients are calculated in the range i=1 to I, respectively.

Setting βi to be less than 1 makes it possible to suppress excessively large contributions from data which does not have a maximum frequency. FIG. 5C illustrates the correction coefficient calculated in this manner. The correction coefficient may be obtained for each bin based on the number of pieces of data in each bin, or may be obtained through a functional approximation based on the values in each bin. When using a functional approximation, the number of pieces of data is particularly high at locations where the class mixing ratio is 0.0 and where the class mixing ratio is 1.0, and thus a non-contiguous function may be used.

In step S2500, the learning unit 2500 performs learning while changing the correction coefficient, based on the class mixing ratio for each identification image.

As described thus far, according to the second variation, the ratio of the correction coefficients between the data having the highest frequency and other data is determined so as to be smaller than the ratio between the number of pieces of the highest-frequency training data and the number of pieces of training data with a lower occurrence frequency. This makes it possible to reduce performance degradation accompanying unevenness in the variation in data while maintaining the overall performance.

Third Variation

In the first embodiment, a correction coefficient for error back propagation is used to control contributions to learning in order to reduce unevenness in the frequency with which data occurs. A third variation will describe a method of padding low-frequency data instead of (or along with) using a correction coefficient for error back propagation.

The configuration of the learning apparatus 5000 according to the third variation is similar to that in FIG. 1A, but the details of the importance changing unit 2400 and the learning unit 2500 are different. Note that the image processing apparatus 1000 according to the third variation is similar to that in the first embodiment, and will therefore not be described.

FIG. 2H illustrates a processing flow of the third variation. Step S2400 of the first embodiment (FIG. 2A) is replaced with step S2410.

In step S2410, the importance changing unit 2400 obtains a data padding amount based on the statistic information obtained from the statistic information calculation unit 2300. This data padding amount is used when optimizing weighting coefficients of the CNN using error back propagation in step S2500, described later. As the data padding amount increases, the contribution to the learning increases, whereas as the data padding amount decreases, the contribution to the learning decreases. In other words, controlling the data padding amount makes it possible to change the degree of importance of the data in the learning.

By increasing the data padding amount for data having a lower frequency of occurrence in FIG. 7A and reducing the data padding amount for data having a higher frequency of occurrence, unevenness in the variation of the data is reduced. Specifically, when DMAX represents the frequency that appears most frequently in FIG. 7A, a data padding amount Wi for data having a frequency of Di is calculated through, for example, Formula (6).

Wi=γ×DMAX/Di (6)

γ is a hyperparameter. i represents the ID of the histogram bin, and if the total number of bins is I, correction coefficients are calculated in the range i=1 to I, respectively. The magnitude of the data padding amount is inversely proportional to the frequency of occurrence, such that the padding amount is lower when the frequency is higher, and the padding amount is higher when the frequency is lower.

FIG. 7C illustrates an example of the data padding amount. In the graph on the left side of FIG. 7C, the distribution is such that minimum values for the padding amount are present in the lower-left and upper-right parts, with the value of the padding amount increasing with proximity to the center. The distribution is also such that there is a peak in the upper-left and the lower-right parts of the graph. By comparing the graph on the left side of FIG. 7A with the graph on the left side of FIG. 7C, it can be seen that as the frequency of occurrence decreases, the data padding amount increases.

A graph in which the data padding amounts are plotted along a dotted line connecting the lower-left and the upper-right of the above-described graph (the left side of FIG. 7C) is indicated on the right side of FIG. 7C. It can be seen that the data padding amount is low at the starting point and the ending point of the graph, and the data padding amount is high near the center.

In step S2500, the learning unit 2500 performs learning based on the training image obtained from the data obtainment unit 2100, the supervisory information expressing the class mixing state obtained from the class mixing ratio calculation unit 2200, and the data padding amount obtained from the importance changing unit 2400. When using error back propagation to back propagate error obtained by comparing the value of the output signal obtained from the output layer 620 and the supervisory signal, changing the data padding amount for each identification image makes it possible to control the contribution to the learning.

To increase the contribution of identification images for which the data padding amount is high, learning is performed having copied the data of the identification images to increase the number of pieces of data. In other words, the number of copies is controlled in accordance with the magnitude of the padding amount. Note that not even a single copy may be made when the padding amount is low.

As described thus far, according to the third variation, the contribution to learning is controlled by controlling the data padding amount. Through this, similar to the first embodiment, learning can be performed for the estimator, taking into account unevenness in variation included in the training data.

### Second Embodiment

The first embodiment described an example in which unevenness in the variation of data is reduced by using class mixing ratios of an identification image and a range including the periphery thereof. A second embodiment will describe reducing unevenness in the variation of data using information on subcategories of classes.

Apparatus Configuration

The configuration of the learning apparatus 5000 according to the second embodiment is similar to that in FIG. 1A, but the details of the training data storage unit 5100, the statistic information calculation unit 2300, and the importance changing unit 2400 are different from those of the first embodiment. Note that the image processing apparatus 1000 according to the second embodiment is similar to that in the first embodiment, and will therefore not be described.

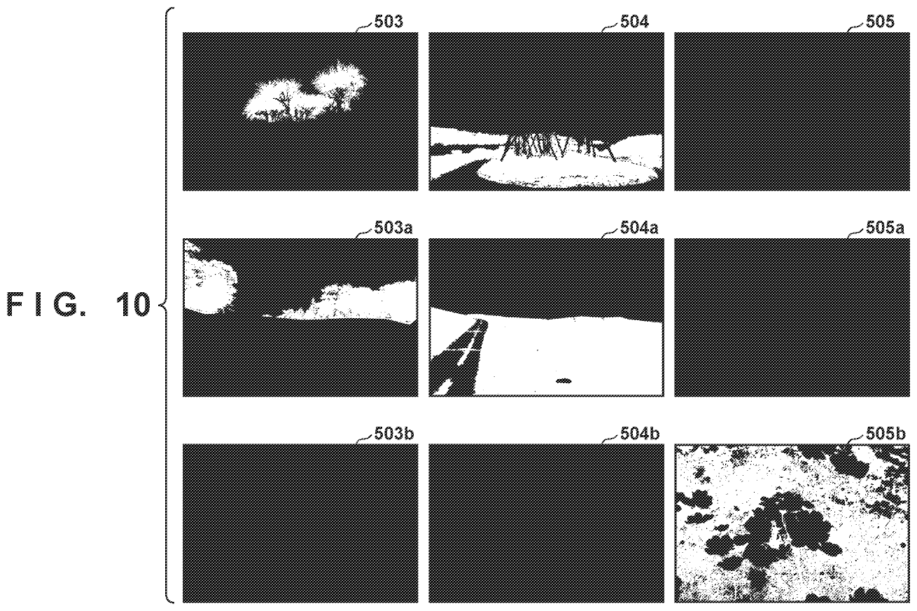

The second embodiment uses information on subcategories of classes. Specifically, assume that three subcategories, namely “tree”, “grass”, and “flower”, are added to the “plant” class. FIG. 10 is a diagram illustrating an example of class labels separated into subcategories.

The plant class labels indicated by the supervisory information 501 in FIG. 3 are separated into three categories, namely “tree”, “grass”, and “flower”, which correspond to supervisory information 503, 504, and 505, respectively. In the supervisory information 501, “trees” are present in the central part, and “grass” is present at the bottom part. There are no “flowers”. The plant class labels indicated by the supervisory information 501a in FIG. 3 are separated into three categories, namely “tree”, “grass”, and “flower”, which correspond to supervisory information 503a, 504a, and 505a, respectively. “Trees” are present at the top part of the screen, and “grass” is present at the bottom part of the screen. The plant class labels indicated by the supervisory information 501b in FIG. 3 are separated into three categories, namely “tree”, “grass”, and “flower”, which correspond to supervisory information 503b, 504b, and 505b, respectively. This image is entirely a field of flowers, and thus only “flowers” are present. Information on subcategories created in this manner is stored in the training data storage unit 5100 as supervisory data.

Apparatus Operations

Although the processing flow according to the second embodiment is similar to that in FIG. 2A, the details of steps S2300, S2400, and S2500 are different. In step S2300, statistic information is calculated for each subcategory of the classes. The specific flow of the processing in step S2300 is illustrated in FIG. 2F. Step S2300 includes step S2350, and the statistic information calculation unit 2300 obtains a statistic amount for each subcategory.

FIGS. 11A to 11C are diagrams illustrating examples of the distribution of frequencies by subcategory. FIG. 11A illustrates a frequency distribution of class mixing ratios of identification images in the subcategory “grass”. For “grass”, there is a large amount of data where the entire identification image has a value of 1, and the data having intermediate values is often at boundary parts, and thus the frequencies tend to be concentrated near 0.0 or 1.0. FIG. 11B illustrates a frequency distribution of class mixing ratios of identification images in the subcategory “tree”. “Trees” are often present in isolation or are mixed with regions such as “sky”, and thus data having intermediate values tends to be present in a relatively uniform manner. FIG. 11C illustrates a frequency distribution of class mixing ratios of identification images in the subcategory “flower”. Many images for “flowers” are fields of flowers, where there tends to be a mixture of leaves and flowers, and the distribution is therefore even more flat than that of “trees”.

Note that when a single identification image is given a class label having a plurality of subcategories, the frequency may be added to a plurality of subcategories with a decimal point value based on the mixing ratios, or 1 may be added only to the subcategory having the highest ratio.

In step S2400, the importance changing unit 2400 calculates the correction coefficient based on the statistic information obtained in step S2300. FIG. 11D illustrates the correction coefficients obtained for each subcategory based on the frequency distributions illustrated in FIGS. 11A to 11C. The correction coefficient is increased for lower frequencies, and the correction coefficient is reduced for higher frequencies.

In step S2500, the learning unit 2500 performs learning while changing the correction coefficient, based on the class mixing ratio and the subcategory for each identification image. By performing learning as described above, unevenness in the variation of the data is reduced according to the nature of the subcategories. Additionally, when there is unevenness in the number of pieces of data in the subcategories of the training data, that unevenness can also be reduced.

Although plants are described as an example in the foregoing, subcategory information can also be used for other classes as well. For example, when detecting a sky region, the region can be divided into subcategories such as “cloudy sky”, “blue sky”, “sunset sky”, and the like. Automobiles, meanwhile, can be divided into “sedan”, “minivan”, “SUV”, “bus”, “truck”, and the like.

Additionally, although a one-dimensional histogram pertaining to the class mixing ratio of the identification image is used for each subcategory, a two-dimensional histogram pertaining to the class mixing ratio calculated for a range including the periphery of the identification image and the class mixing ratio of the identification image may be used, similar to the first embodiment. Orientation information may be used as well, as in the first variation.

As described thus far, according to the second embodiment, statistic amounts are calculated for each of subcategories, and correction coefficients are obtained and used in the learning. When characteristics are different for each subcategory in each class, some categories are prone to data unevenness, while some categories are not, and thus by performing such calculations, learning for the estimator can be performed while taking into account unevenness in the variation of the training data.

### Third Embodiment

The second embodiment described an example of reducing unevenness in the variation of data using information on subcategories of classes. A third embodiment will describe reducing unevenness in the variation of data by using information on camera parameters used in shooting and other information added to the image.

Apparatus Configuration

The configuration of the learning apparatus 5000 according to the third embodiment is similar to that in FIG. 1A, but the details of the training data storage unit 5100, the statistic information calculation unit 2300, and the importance changing unit 2400 are different from those of the first embodiment. Note that the image processing apparatus 1000 according to the third embodiment is similar to that in the first embodiment, and will therefore not be described.

Apparatus Operations

Although the processing flow in the learning apparatus 5000 according to the third embodiment is similar to that in FIG. 2A, the details of steps S2300, S2400, and S2500 are different.

In step S2300, the statistic information calculation unit 2300 calculates the statistic information based on camera parameters at the time of shooting the captured image data, which is the input data. Here, the “camera parameters” relate to parameters from the time of shooting the image, such as the brightness of the subject (information indicating the brightness of the shot scene), called “Bv”; the shutter speed; the aperture value; the depth value; GPS information; shooting date/time; and the like. In the present embodiment, Bv will be used as an example. Bv can be calculated through Formulas (7) to (10), from the exposure time (seconds) T, the aperture value (F value) A, and the ISO sensitivity value Sx, which are image capturing conditions.

Bv=Tv+Av−Sv (7)

Tv=−log₂T (8)

Av=2·log₂A (9)

Sv=log₂(0.32·Sx) (10)

As a guide, the value of Bv is approximately 7 to 10 during the day outdoors, around 5 in a bright setting indoors, about 1 to 2 in a dark setting indoors, −1 outdoors at night, and so on. The brightness at which a subject has been shot can be grasped from the value of Bv. The information on the camera parameters from the time of shooting is stored in the training data storage unit 5100 as information added to the training image in advance.

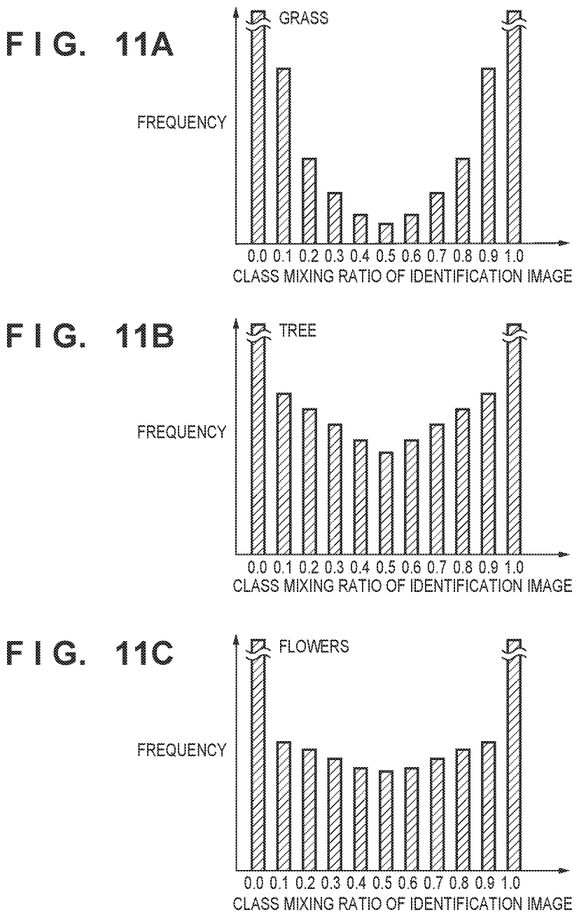

The specific flow of the processing in step S2300 is illustrated in FIG. 2G. Step S2300 includes step S2360, and the statistic information calculation unit 2300 calculates Bv from the exposure time, the F value, and the ISO sensitivity value, which are the parameters at the time of shooting, for each image in the training data. Next, a two-dimensional histogram is generated by associating the class mixing ratios of the identification images in each image. When the horizontal axis represents the class mixing ratio of the identification image and the vertical axis represents Bv, a two-dimensional histogram such as that illustrated in FIG. 12A is generated.

FIG. 12A is a diagram illustrating an example of a two-dimensional histogram based on class mixing ratios and Bv values. Analyzing the histogram in FIG. 12A makes it possible to grasp which Bv scenes are insufficient. For example, when the Bv is low and there is a low distribution of regions where the class mixing ratio of the identification image is high, as indicated by the part surrounded by the dotted line in FIG. 12A, this indicates that there are few images of plants shot in the dark indoor scenes or outdoor night scenes.

In step S2400, the importance changing unit 2400 calculates the correction coefficient based on the statistic information obtained in step S2300. In other words, there is unevenness in the data, and thus a correction coefficient is obtained to reduce that unevenness.

FIG. 12B is a diagram illustrating an example of correction coefficients based on the class mixing ratio and the Bv value. As illustrated in FIG. 12B, unevenness in the data is reduced by using a correction coefficient of 1 where there is sufficient data and using a correction coefficient of 10 where data occurs less frequently or the like. Through this, learning is performed appropriately even for data that occurs infrequently, which improves the recognition accuracy.

Although an example of the Bv value has been described here, using information on, for example, the shooting date/time makes it possible to grasp unevenness in the data, such as which months have more data and which months have less data. If such monthly data indicates that there are few images of plants in the winter, increasing the correction coefficient for training images from that period makes it possible to improve the detection performance of plants in the winter, for which there are few images.

Additionally, using GPS data makes it possible to grasp which areas have more images shot and which areas have fewer images shot. For example, if there are more images from Europe and fewer images from Asia, increasing the correction coefficient for images from Asia makes it possible to improve the detection performance for the areas from which there are fewer images.

Information added to images, aside from the camera parameters (e.g., information on the person who added the class labels, information on the continuous working time required for class labeling, and so on), can also be used.

For example, if there is variation in the quality of the class labeling by each person, unevenness will arise in the quality of the class labels when there is only data which has been labeled by a specific person. Increasing the correction coefficient for data labeled by a person who has labeled a lower number of pieces of data makes the quality of the class labels more uniform.

Additionally, labeling classes is a task which requires concentration, and thus the longer work is done continuously before the labeling of the training data in question is added, the more the quality of the class labels may drop. Accordingly, the continuous working time and the quality of the class labels may also be correlated. Suppressing unevenness in the continuous working time makes the quality of the class labels more uniform.

As described thus far, according to the third embodiment, a statistic amount is calculated based on camera parameters, other information added to the images, and so on, and a correction coefficient is obtained and used in the learning. Performing such calculations makes it possible to perform learning for the estimator having taken into account unevenness in the camera parameters, the quality of class labels, and so on included in the training data.

### Fourth Embodiment

In the first to third embodiments, a method of recognizing mixing states of classes in identification images obtained by dividing an input image into rectangular regions is used as a semantic region segmentation task. In the fourth embodiment, a method of performing class determination for each pixel in the input image is used. The statistic information calculated is the same as the statistic information of the orientation information in a range including the periphery of a pixel of interest, used in the first variation.

Apparatus Configuration

The configuration of the image processing apparatus 1000 according to the fourth embodiment is similar to that in FIG. 1A, but the details of the estimation unit 1200 differ from those of the first embodiment. Specifically, the output of the estimation unit 1200 is not a mixing state of the identification images, but rather a class determination for each pixel.

The configuration of a learning apparatus 6000 according to the fourth embodiment is illustrated in FIG. 1C. The difference is that the class mixing ratio calculation unit 2200 included in FIG. 1B is not provided here. This is because in the fourth embodiment, class determination for each pixel is performed instead of estimating the mixing state of the identification image.

Apparatus Operations

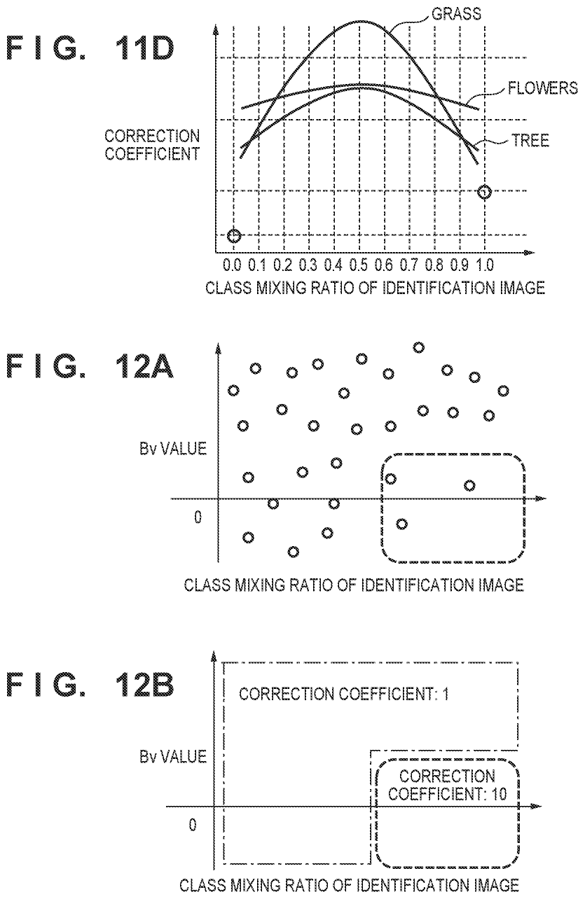

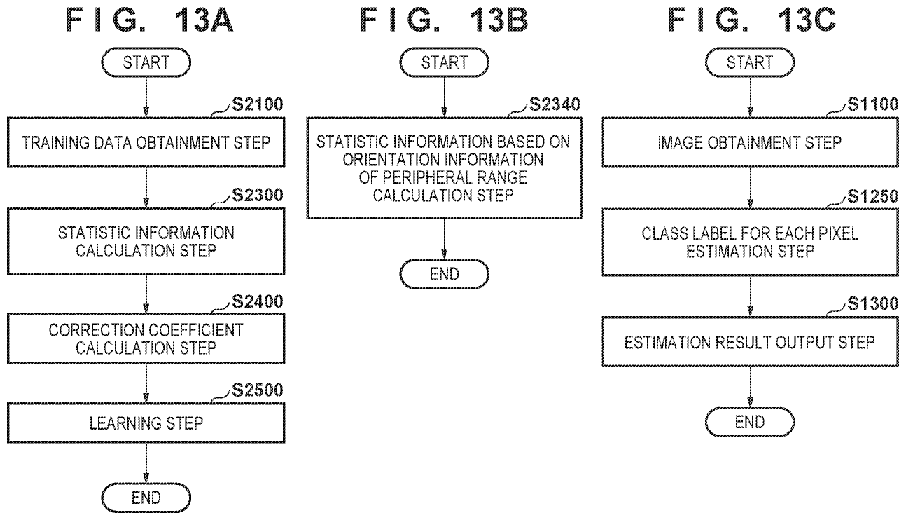

FIG. 13C is a flowchart illustrating operations performed by the image processing apparatus according to the fourth embodiment. The difference from FIG. 2C is that step S1200 has been replaced with step S1250. Steps S1100 and S1300 are similar to those of the first embodiment, and will therefore not be described.

In step S1250, the estimation unit 1200 estimates class labels at the same resolution as the resolution of the input image. In other words, the resolution of the input image and the resolution of the output map are the same, and the class label having the highest likelihood is estimated for each pixel in the input image.

A network structure called U-Net, described above in Document B, can be used as the estimator, for example. This network can achieve highly-accurate class label estimation at the same resolution as the resolution of the input image by performing processing for reducing the resolution in the pooling layers and then increasing the resolution in upsampling layers. There is also a method called “skip connection”, which inputs the feature map prior to pooling into a convolutional layer having the same resolution after the upsampling. However, the estimator which can be used in the present embodiment is not limited to U-Net.

FIG. 13A is a flowchart illustrating operations performed by the learning apparatus according to the fourth embodiment. The difference from FIG. 2A is that step S2200 is not included.

In step S2100, the data obtainment unit 2100 obtains the training images and the supervisory information pertaining to the region as the training data from the training data storage unit 5100. In the present embodiment, supervisory information on the class label for each pixel is used directly as supervisory information.

In step S2300, the statistic information calculation unit 2300 obtains the supervisory information on the class label for each pixel from the data obtainment unit 2100, and calculates statistic information. The specific flow of the processing in step S2300 is illustrated in FIG. 13B.

Step S2300 includes step S2340, and the statistic information calculation unit 2300 calculates the statistic information for each pixel in the input image. The statistic information is calculated for all pixels in all N of the training images. The present embodiment assumes that the size of the training images is the QVGA size, i.e. 320×240, and there are thus 76,800 pixels in each image. This applies to the N images, and thus the total amount of information is N×76,800 pixels.

The present embodiment uses the statistic information of the orientation information in a range including the periphery of a pixel of interest, used in the first variation. In other words, a center of gravity position of the class label is obtained in a range including a peripheral region of the pixel of interest, as described with reference to FIGS. 8A and 8B, and the orientation information is calculated from the center of gravity position.

In step S2400, the importance changing unit 2400 obtains a correction coefficient based on the statistic information obtained from the statistic information calculation unit 2300. When the orientation information is obtained for all pixels in the N training images and a distribution of the frequencies is found, frequencies similar to those in FIG. 8C are obtained. As described in the first variation, there is more data in the vicinity of an orientation of ±180°, and less data for other orientations. Accordingly, as illustrated in FIGS. 8C and 8D, the correction coefficient is increased for orientations having lower frequencies, and the correction coefficient is reduced for orientations having higher frequencies. Formula (1) can be used when calculating the correction coefficient from the frequency.

In step S2500, the learning unit 2500 learns parameters for feature extraction and parameters of the output layer for the estimator, exemplified by U-Net as described above. First, the value of the output signal from the estimator is compared with the supervisory signal, and error is obtained. The estimator can be trained by sequentially propagating the error obtained in this manner from the output layer to the input layer using error back propagation. When applying error back propagation, performing learning while changing the correction coefficient based on the orientation for each pixel makes it possible to reduce unevenness in the variation of the orientation information in the class label data.

As described thus far, the fourth embodiment has described performing class determination on each pixel of an input image as a semantic region segmentation task. Even in such a task, the correction coefficient is increased for relatively large numbers of data, and the correction coefficient is reduced for relatively small numbers of data. Through this, learning can be performed for the estimator, taking into account unevenness in variation included in the training data.

### Fifth Embodiment

The first to fourth embodiments described examples of the present invention being applied to region detection tasks. A fifth embodiment will describe an example of the present invention being applied to an object detection task. An object detection task is a task of outputting a range in which an object is present in an image as a rectangular frame. A variety of targets can be given as targets for detection, such as a person's entire body, a person's face, a person's eyes, animals, vehicles, and the like. The present embodiment will describe the task of detecting a person's face as an example.

Apparatus Configuration

The configuration of the image processing apparatus 1000 according to the fifth embodiment is similar to that in FIG. 1A, but the estimation unit 1200 and the output unit 1300 differ from those of the first embodiment. The estimation unit 1200 uses the estimator 600 to estimate a center map and a size map of a detection target as output maps. The output unit 1300 outputs an object detection frame of the detection target based on the center map and the size map estimated by the estimation unit 1200.

The learning apparatus according to the fifth embodiment has a configuration similar to the learning apparatus 6000 of the fourth embodiment, illustrated in FIG. 1C. Differences from the first embodiment will be described when describing the flowchart in FIG. 13A.

Apparatus Operations

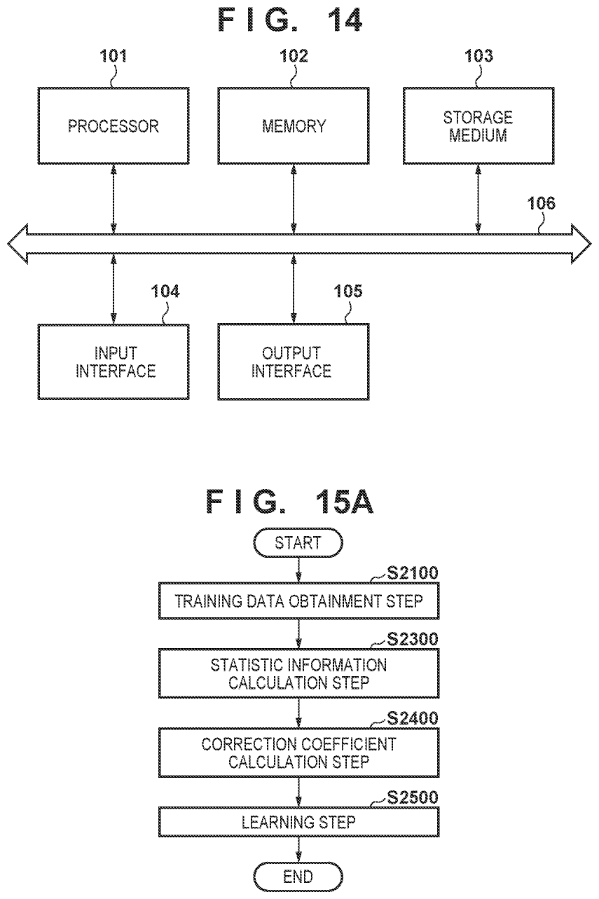

FIG. 15C is a flowchart illustrating operations performed by the image processing apparatus according to the fifth embodiment. In step S1100, the image obtainment unit 1100 obtains input images.

In step S1280, the estimation unit 1200 loads a pre-trained estimator from the estimator storage unit 5200, and estimates a center map and size maps. The estimator 600 that uses the CNN illustrated in FIG. 4A can be used as the estimator. Although FIG. 4A illustrates the output map as a single map, in the present embodiment, three maps are output as the output map, namely a center map, an X direction size map, and a Y direction size map.

In step S1290, the output unit 1300 calculates and outputs an object detection frame based on the center map and the size maps obtained in step S1280. Specifically, a peak position of a feature on the center map is calculated, and that position is taken as a center position of the object. The values of the size maps are obtained for the same position as the center position of the object, and those values are taken as the size of the object. The size of the X direction is obtained from the X direction size map, and the size in the Y direction is obtained from the Y direction size map.

FIG. 15A is a flowchart illustrating operations performed by the learning apparatus according to the fifth embodiment. In step S2100, the data obtainment unit 2100 obtains the training images and the supervisory information pertaining to the object frame as the training data from the training data storage unit 5100. The training data is stored in the training data storage unit 5100 in advance.

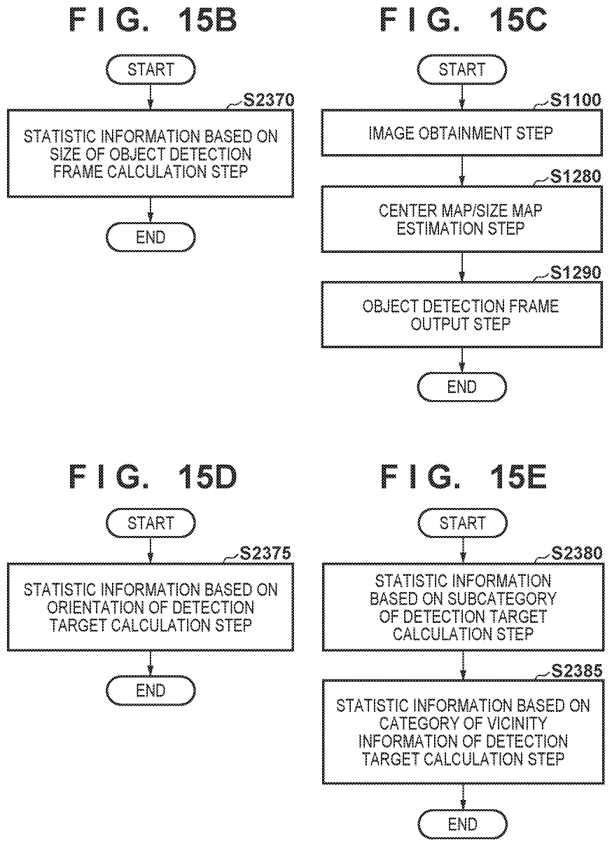

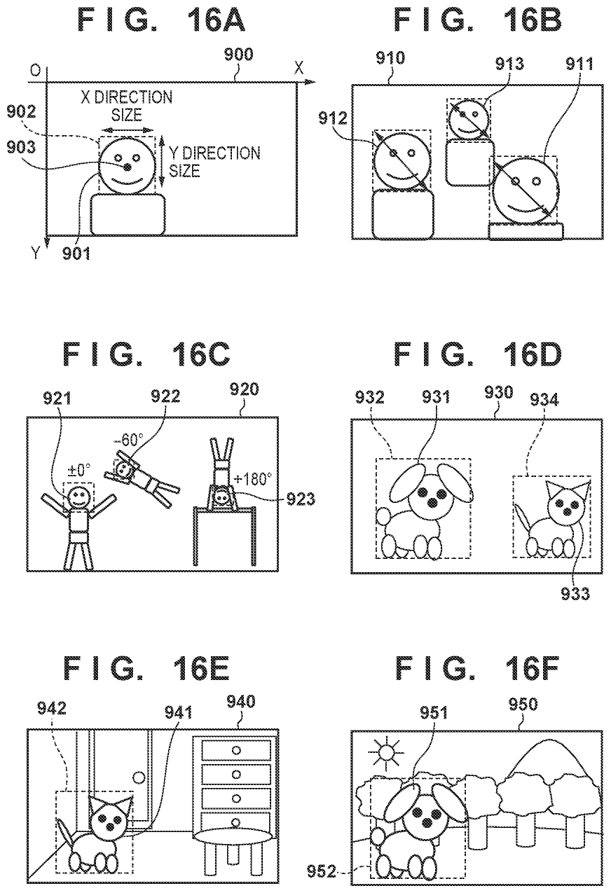

FIG. 16A is a diagram illustrating an example of the training data in the object detection task. The training data includes training images and supervisory information. The detection target in the fifth embodiment is “a person's face”, and thus the supervisory information will be described using training images 900 in which people have been captured. The supervisory information is information of a rectangular frame 902 surrounding a person's face 901. The information of the rectangular frame is, specifically, four numerical values, namely a “X coordinate value” and a “Y coordinate value” of a center point 903 of the rectangular frame, and a “X direction size” and a “Y direction size” of the rectangular frame.

In step S2300, the statistic information calculation unit 2300 calculates the statistic information. A detailed processing flowchart of step S2300 is illustrated in FIG. 15B, and in step S2370, the statistic information of the size of the object detection frame is calculated.

As illustrated in FIG. 16B, the size of the object detection frame is assumed to be the length of a diagonal of the frame. The length of the diagonal can be obtained by taking the square root of the sum of squares of the X direction size and the Y direction size of the rectangular frame. An image 910 is an image in which the faces of three people have been captured. FIG. 16B illustrates frames related to three faces 911, 912, and 913, as well as the lengths of the diagonals of the frames. The present embodiment assumes that the sizes of the training images are the QVGA size, i.e., 320×240, and thus the maximum value of the length of the diagonal of the object detection frame is 400 pixels. The length of the diagonal of the frame is expressed as a normalized number, such that the maximum size of “400” is indicated as “1.0”.

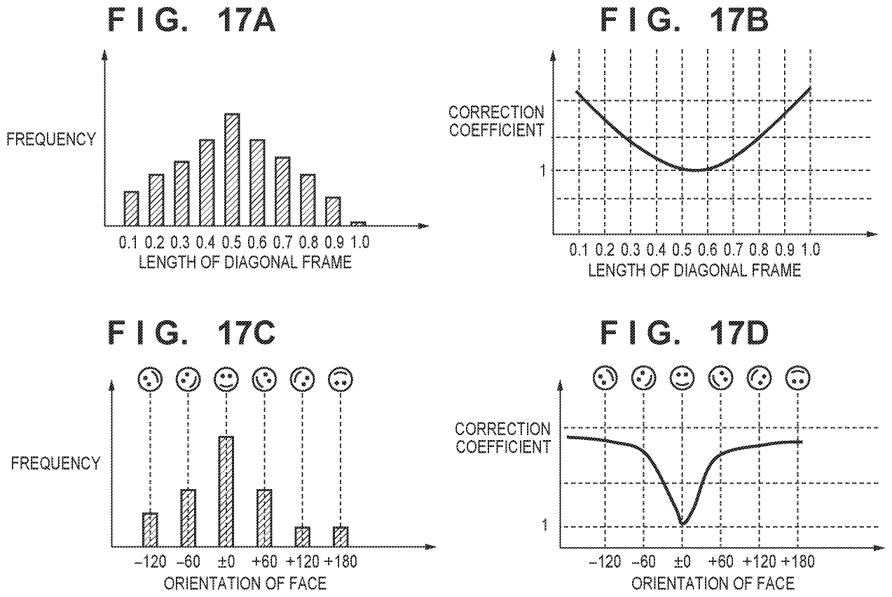

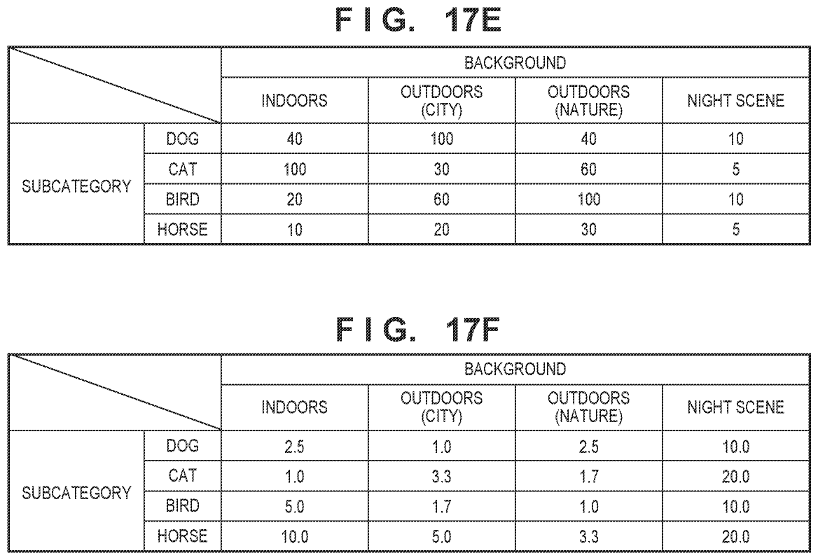

By calculating the length of the diagonal of the object detection frame for all of the supervisory information included in the training data, statistic information on the lengths of the diagonals of the object detection frames is obtained. FIG. 17A illustrates an example of the statistic information on the lengths of the diagonals of the object detection frames. The horizontal axis represents the length of the diagonal of the object detection frame, and the vertical axis represents the frequency. Although dependent on the type of the object to be detected, variation in the images included in the data set, and the like, it is assumed here that the greatest frequency for the length of the diagonal of the frame is an intermediate size (0.5). The frequencies of small sizes (less than 0.5) and large sizes (greater than 0.5) are relatively low. In such circumstances, smaller sizes and larger sizes will contribute less to the learning, and thus the recognition accuracy will drop.

In step S2400, the importance changing unit 2400 obtains a correction coefficient based on the statistic information obtained from the statistic information calculation unit 2300. As illustrated in FIG. 17B, the correction coefficient is reduced as the frequency of occurrence increases, and the correction coefficient is increased as the frequency of occurrence decreases.

In step S2500, the learning unit 2500 performs learning based on the training images obtained from the data obtainment unit 2100 and the correction coefficient obtained from the importance changing unit 2400. More specifically, the learning unit 2500 learns the parameters of the feature extraction unit 610 and the output layer 620 of the estimator 600 indicated in FIG. 4A. The learning unit 2500 converts the information on the object detection frame, which is the supervisory information, into supervisory signals of the center map and the size maps, which are then used for learning.

The supervisory signal of the center map gives a value of “1” to a center coordinate position of the object detection frame. The supervisory signal of a size map gives a value of the size to the range of the object detection frame assuming that the maximum size of “400” is normalized to “1”. For example, when the X direction size is 100 pixels, a value of 0.25 (=100/400) is given to the X direction size map.

When performing learning for the estimator 600, the learning unit 2500 compares a supervisory signal with the value of an output signal obtained from the output layer 620 when an image obtained from a predetermined position of a training image is input to the CNN, and obtains error. The error is calculated for both the center map and the size maps. The CNN can be trained by sequentially back propagating the error obtained in this manner from the output layer to the input layer using error back propagation.

When sequentially back propagating error from the output layer to the input layer using error back propagation, changing the correction coefficient for each identification image makes it possible to control the contribution to the learning. The method for controlling the contribution using the correction coefficient is similar to that in the first embodiment, and will therefore not be described. The correction coefficient becomes large for small faces and large faces, which occur less frequently, and thus learning is performed appropriately even for small faces and large faces, which improves the recognition accuracy.

As described thus far, according to the fifth embodiment, learning is performed through correction using statistic information. Accordingly, a drop in the recognition accuracy caused by unevenness in the data can be reduced even in object detection tasks.

Fourth Variation

Although the foregoing fifth embodiment described using statistic information based on the size of a frame around a person's face, a fourth variation will describe an example of using statistic information based on the orientation of a person's face. Note that the configurations of the learning apparatus and the image processing apparatus are similar to those described in the fifth embodiment, and will therefore not be described here. Additionally, operations of the image processing apparatus are similar to those described in the fifth embodiment, and will therefore not be described here.

Apparatus Operations

The flowchart illustrating the operations of the learning apparatus according to the fourth variation is similar to that of the fifth embodiment (FIG. 15A).

In step S2100, the data obtainment unit 2100 obtains the training images and the supervisory information pertaining to the object frame as the training data from the training data storage unit 5100. FIG. 16C illustrates an example of the training data in the fourth variation. The training data is constituted by training images and supervisory information, but in the fourth variation, “information on a rectangular frame surrounding a person's face” and “information on the orientation of a person's face” are used as the supervisory information. Specifically, in addition to the information on a rectangular frame surrounding a person's face illustrated in FIG. 16C, information pertaining to the orientation of the face within that frame is added as well. Three types of definitions, namely roll, pitch, and yaw, exist as information indicating orientation, but in the fourth variation, roll is used. The orientation information for a face 921 is “±0°”, the orientation information for a face 922 is “−60°”, and the orientation information for a face 923 is “+180°”.

In step S2300, the statistic information calculation unit 2300 calculates the statistic information. A detailed processing flowchart of step S2300 is illustrated in FIG. 15D, and in step S2375, statistic information based on the orientation of the detection target is calculated. The statistic information based on the orientation of the detection target can be calculated by referring to the information on the orientation of a person's face in all of the supervisory information included in the training data.

FIG. 17C illustrates an example of the statistic information on the orientation of faces. The horizontal axis represents the face orientation, and the vertical axis represents the frequency. Although dependent on the type of the object to be detected, variation in the images included in the data set, and the like, it is assumed here that the distribution is such that the frequency increases as the orientation of the face approaches 0°. Accordingly, orientations for which the absolute value of the angle is high have a lower frequency. In such circumstances, face orientations for which the absolute value of the angle is high will contribute less to the learning, and thus the recognition accuracy will drop.

In step S2400, the importance changing unit 2400 obtains a correction coefficient based on the statistic information obtained from the statistic information calculation unit 2300. As illustrated in FIG. 17D, the correction coefficient is reduced as the frequency of occurrence increases, and the correction coefficient is increased as the frequency of occurrence decreases.

In step S2500, the learning unit 2500 performs learning based on the training images obtained from the data obtainment unit 2100 and the correction coefficient obtained from the importance changing unit 2400. The details of the learning are similar to those in the fifth embodiment, and will therefore not be described here. The correction coefficient is large for face orientations for which the absolute value of the angle is high, which appear with lower frequency, and thus learning is performed appropriately even for such face orientations, which improves the recognition accuracy.

Fifth Variation

The foregoing fifth embodiment described a person's face as the detection target, but a fifth variation will describe an animal as the detection target. Additionally, an example in which information on subcategories of animals, and information on backgrounds in which detection targets are present (scene information), is used as the statistic information will be described. Note that the configurations of the learning apparatus and the image processing apparatus are similar to those described in the fifth embodiment, and will therefore not be described here. Additionally, operations of the image processing apparatus are similar to those described in the fifth embodiment, and will therefore not be described here.

Apparatus Operations

The flowchart illustrating the operations of the learning apparatus according to the fourth variation is similar to that of the fifth embodiment (FIG. 15A).

In step S2100, the data obtainment unit 2100 obtains the training images and the supervisory information pertaining to the object frame as the training data from the training data storage unit 5100. FIGS. 16D to 16F illustrate an example of the training data in the fifth variation. Although the training data is constituted by training images and supervisory information, in the fifth variation, “information on a rectangular frame surrounding an animal”, “information on a subcategory of an animal”, and “information on a background where an animal is captured (scene information)” are used as the supervisory information.

As illustrated in FIG. 16D, the information on the rectangular frame includes a center image coordinate value, an X direction size, and a Y direction size of the rectangular frame surrounding the animal. Specifically, this is information specifying a frame 932 surrounding a dog 931 and a frame 934 surrounding a cat 933. Information on the subcategory of the animal is also added to each rectangular frame. Specifically, information indicating “dog” is added to the frame 932 of the dog 931, and information indicating “cat” is added to the frame 934 of the cat 933.

Furthermore, information on the background where the subject (the animal) is captured (scene information) is added. Specifically, “indoors” is added to a frame 942 surrounding a cat 941, illustrated in FIG. 16E, and “outdoors (nature)” is added to a frame 952 surrounding a dog 951, illustrated in FIG. 16F. Background information is used in this manner because in object detection tasks, the difficulty of detection changes depending on the combination of the background and the target object. To use a specific simple example, a black cat against a black wall will blend in with the background, which reduces the rate of detection. In this manner, the combination of the subcategory of the target object and the background information is important in object detection tasks.

In step S2300, the statistic information calculation unit 2300 calculates the statistic information. A detailed processing flowchart of step S2300 is illustrated in FIG. 15E, and in step S2380, statistic information based on the subcategory of the detection target is calculated. In step S2385, statistic information based on the background information of the detection target is calculated. The statistic information of the detection target can be calculated by referring to the subcategory information and background information for all the supervisory information included in the training data. FIG. 17E illustrates an example of statistic information calculated based on the subcategory information and the background information. Occurrence frequencies for respective combinations of subcategory information and background information are shown in table format. The contribution to the learning decreases for combinations which appear less frequently, and thus the recognition accuracy drops.

In step S2400, the importance changing unit 2400 obtains a correction coefficient based on the statistic information obtained from the statistic information calculation unit 2300. As illustrated in FIG. 17F, the correction coefficient is reduced as the frequency of occurrence increases, and the correction coefficient is increased as the frequency of occurrence decreases.

In step S2500, the learning unit 2500 performs learning based on the training images obtained from the data obtainment unit 2100 and the correction coefficient obtained from the importance changing unit 2400. The details of the learning are similar to those in the fifth embodiment, and will therefore not be described here. The correction coefficient increases for combinations which appear less frequently, and thus learning is performed appropriately even for combinations which appear less frequently, which improves the recognition accuracy.

### OTHER EMBODIMENTS

The first to fourth embodiments and the first to third variations described examples of applications to region detection tasks. Additionally, the fifth embodiment and the fourth and fifth variations described examples of applications to object detection tasks. In this manner, the present invention can be applied to a variety of recognition tasks, and can be applied to scene recognition tasks, image classification tasks, authentication tasks, and the like as well, for example.

Additionally, although the first to fifth embodiments and the first to fifth variations described examples in which two-dimensional image data is used as the input data, the input data to which the present invention is applicable is not limited to image data.

For example, the present invention can also be applied in voice recognition using voice data, which is one-dimensional information. When collecting data for voice recognition, statistic information on attribute information, such as the age, gender, and the like of the person who produced the voice, can be used, and unevenness in the variation thereof causes differences in the performance. For example, if the number of pieces of data for a man in his thirties is lower than that of other data, the performance will drop for that insufficient data. By applying the present invention, the correction coefficient used during learning can be increased for the insufficient data, which reduces unevenness in the variation and leads to an improvement in the overall performance.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-206255, filed Dec. 20, 2021, and Japanese Patent Application No. 2022-148404, filed Sep. 16, 2022 which are hereby incorporated by reference herein in their entirety.

What is claimed is:

1. A learning apparatus that trains an estimator that executes a recognition task, the learning apparatus comprising:
an obtaining unit configured to obtain a plurality of training data items including input data and supervisory data corresponding to the input data;
a calculating unit configured to calculate statistic information relating to a predetermined perspective in the plurality of training data items obtained by the obtaining unit;
a determining unit configured to determine a degree of importance of each training data item included in the plurality of training data items based on the statistic information; and
a control unit configured to control training of the estimator based on the degree of importance determined by the determining unit,
wherein the determining unit determines the degree of importance of each training data item such that unevenness of the plurality of training data items with respect to the predetermined perspective is reduced.

2. The learning apparatus according to claim 1,
wherein the recognition task is a region detection task.

3. The learning apparatus according to claim 1,
wherein the recognition task is an object detection task.

4. The learning apparatus according to claim 2,
wherein the input data is image data,
the supervisory data is label data indicating a class label of each of regions in the image data, and
the estimator estimates the class label of a target object included in the image data.

5. The learning apparatus according to claim 4,
wherein the calculating unit calculates a mixing state of the class labels in the plurality of training data items.

6. The learning apparatus according to claim 4,
wherein the calculating unit divides each training data item into a plurality of partial regions, and for each partial region, calculates first statistic information and second statistic information, the first statistic information being a mixing state of class labels within the partial region, and the second statistic information being a mixing state of class labels including a peripheral partial region, and
the determining unit determines the degree of importance of each training data item based on the first statistic information and the second statistic information.

7. The learning apparatus according to claim 6,
wherein the second statistic information includes statistic information pertaining to a direction of a center of gravity position of each of the class labels with respect to a center position of a partial region of interest.

8. The learning apparatus according to claim 1,
wherein the control unit controls the training of the estimator by relatively increasing a correction coefficient for training data item having a relatively high degree of importance determined by the determining unit.

9. The learning apparatus according to claim 1,
wherein the control unit controls a padding amount of each training data item used to train the estimator such that a total number of training data items having a relatively high degree of importance determined by the determining unit is relatively high.

10. The learning apparatus according to claim 4,
wherein subcategories are set for the class labels of the target object in the supervisory data, and
the calculating unit calculates the statistic information for each of the subcategories.

11. The learning apparatus according to claim 1,
wherein the input data is captured image data,
the obtaining unit further obtains camera parameters used when the captured image data was shot, and
the calculating unit calculates statistic information pertaining to the camera parameters.

12. The learning apparatus according to claim 11,
wherein the camera parameters include at least one of a Bv value, an exposure time, an F value, an ISO sensitivity value, a shooting date and time, and GPS information.

13. A control method of a learning apparatus that trains an estimator that executes a recognition task, the control method comprising:
obtaining a plurality of training data items including input data and supervisory data corresponding to the input data;
calculating statistic information relating to a predetermined perspective in the plurality of training data items obtained in the obtaining;
determining a degree of importance of each training data item included in the plurality of training data items based on the statistic information; and
controlling training of the estimator based on the degree of importance determined in the determining,
wherein in the determining, the degree of importance of each training data item is determined such that unevenness of the plurality of training data items with respect to the predetermined perspective is reduced.

14. A non-transitory computer-readable recording medium storing a program for causing a computer to execute a control method of a learning apparatus that trains an estimator that executes a recognition task, the control method comprising:
obtaining a plurality of training data items including input data and supervisory data corresponding to the input data;
calculating statistic information relating to a predetermined perspective in the plurality of training data items obtained in the obtaining;
determining a degree of importance of each training data item included in the plurality of training data items based on the statistic information; and
controlling training of the estimator based on the degree of importance determined in the determining,
wherein in the determining, the degree of importance of each training data item is determined such that unevenness of the plurality of training data items with respect to the predetermined perspective is reduced.
